(19) United States
(12) Patent Application Publication
(10) Pub. No.: US 2018/0172981 A1
(43) Pub. Date: Jun. 21, 2018

(54) WEARABLE DISPLAY

(71) Applicant: Fusao Ishii, Pittsburg, PA (US)

(72) Inventor: Fusao Ishii, Pittsburg, PA (US)

(21) Appl. No.: 15/381,658

(22) Filed: Dec. 16, 2016

(51) Int. Cl. G02B 26/08; G02B 27/00; G02B 5/32; G02B 27/01; G03B 21/14; G02B 27/48; G09G 3/34

(52) U.S. Cl. CPC G02B 26/0841; G02B 27/0037; G02B 5/32; G02B 27/0018; G02B 27/0172; G02B 2027/012; G02B 27/0068; G02B 27/48; G09G 3/346; G02B 2027/0174; G02B 2027/011; G03B 21/147

(57) ABSTRACT

An image display system including tangential outgoing projected light combined with holographic optical element is disclosed. This invention enables very small compact wearable display suitable eyewear display with complete stealth characteristic, electronic vision control and very high solution having large FOV and Eye Box.

### CROSS REFERENCE TO RELATED APPLICATIONS

This application is a Non-Provisional application and claims the Priority Dates of previously filed Provisional Applications 61/957,258 filed on Jun. 27, 2013, 61/958,491 filed on Jul. 29, 2013, 61/959,953 filed on Sep. 7, 2013, 61/966,519 filed on Feb. 25, 2014 and 61/995,664 on filed on Apr. 17, 2014.

### TECHNICAL FIELD

This invention relates to a display system for projecting an image with a spatial light modulator having outgoing light to a tangential direction and key components enabling super compact wearable display. More particularly, this invention relates to a display suitable for wearable displays with very small form factor.

### BACKGROUND ART

Wearable displays get attention in recent years after smart phones are well accepted by the market. Wearable display provides hands free operation as well as showing image in the distance same as regular sight. There are tremendous needs for wearable displays. However in the past, near eye displays such as Head Mount Display, Head Up Display and Eye Glass Type Display not necessarily satisfied viewers, because they were often too heavy, too large, too dark, low resolution, not see through and/or expensive. There are needs for light, small, bright, high resolution, see-through, stealth and inexpensive. This invention provides a new display system which satisfies all of these needs.

As shown in FIG. 1 and FIG. 1A, Kasai et al. disclose in U.S. Pat. No. 7,460,286 an eye glass type display system that implements see-through capability with a holographic optical element. This display system projects images in the normal direction from display device, more particularly perpendicular direction for a surface of LCD display, and projected light containing an image is led into optical wave guide and reflected toward the eye of viewer. Because the outgoing projected light is normal direction to the display device, the form factor of eyewear display becomes large.

As shown in FIG. 2 and FIG. 2A, Mukawa et al. in SID 2008 Digest, ISSN/008-0966X/08/3901-0089, “A Full Color Eyewear Display using Holographic Planar Waveguides”, disclose an eye glass type display system that implements see-through capability with two plates of holographic optical elements. This system also has the same configuration and normal direction projection makes the system large.

As shown in FIG. 3, Levola in SID 2006 Digest, ISSN0006-64 •SID 06 DIGEST 0966X/06/3701-0064, Novel Diffractive Optical Components for Near to Eye Displays discloses another implementation locating LCD device in the middle of two eyes, but still it requires large protruded space which enlarge the form factor. The above three types of displays are using either holographic optical element (HOE) or diffractive optical element (DOE) and all of these have some fundamental difficulties of large chroma aberration, cross talk of colors, large field curvature aberration and distortion aberration. Mukawa et al. explained how to reduce cross talk of colors using multiple wave guides, which makes the system heavier and thicker and the efficiency of utilization of light will be lower. Kasai et al. used a single HOE which helped to improve the efficiency of light utilization, although the other aberrations remained and the FOB (field of view) has to be small so that these aberrations will not be conspicuous. This invention will show how these difficulties will be removed.

As shown in FIG. 4 and FIG. 4A, Li et al. disclosed in U.S. Pat. No. 7,369,317 a compact display and camera module attachable to eye glasses. This also requires a thick PBS (polarized beam splitter) and the FOB (field of view) is rather small and this is not stealth and the presence of display is very obvious. These inventions are using LCD as display device and because of its structure, the outgoing light containing images is projected to the normal (perpendicular) direction to the These prior arts described above have difficulties to meet all of the needs including light, small, bright, high resolution, see-through, stealth and inexpensive. Therefore there is a need of wearable display for substantially smaller and higher resolution with lower power consumption.

### SUMMARY OF THE INVENTION

It is an aspect of this invention to provide a micromirror to combine with HOE or DOE wherein the micromirror are controllable to project light either to a normal (perpendicular) direction or a tangential direction. The micromirrors with perpendicular projection are more commonly implemented because of the more straightforward optical design. In this invention, micromirrors project tangential lights with tilted angle are combine with HOE or DOE to achieve display device with significantly reduced dimensions. The optical designs are based on intensive study that reveals significant advantages of tilted projection, i.e., projecting away from the normal-perpendicular direction and commonly known as tangential projection, when combined with HOE or DOE. This invention specifically discloses the advantages of ultra-small form factor of the system as well as substantial reduction of aberrations such as field curvature and distortion

One aspect of this invention is to provide a reflective type display device that is specially configured to output projected light substantially along a tangential direction. Specifically, the light is projected to the display surface along a direction away from the normal/perpendicular direction of display device. “Tangential Direction” means that the reflected light from a device containing a bright (positive) image wherein the reflected light is projected along a tilted angle rather than the normal direction to the surface of display device. This is achieved by a device such as micro-mirror by reversing the positive and negative signals from the signals applied to the conventional micromirror device. Conventional micro-mirror projects a positive image (ON state) toward the normal direction and a negative image (OFF state) toward tangential direction where a light absorber is placed. It is an aspect of this invention that the input video signals are reversed such that the light for image display is projected along a tangential direction instead of along a normal or perpendicular direction. The size of a wearable display device is significantly reduced. Particularly, a display device applying the tangential image projection of this invention reduces the size of eyewear displays substantially and small form factor is achieved.

Another aspect of this invention is to provide an optical system using HOE or DOE to reduce the aberrations of field curvature and distortion. An intensive study revealed that a simple method to minimize these distortions exists. The method is called as “Cubic Trigonometric Correction”.

Another aspect of this invention is to provide a system of electronic visual control to adjust focal length for viewer's eye such as near sighted, far sighted and senior vision rather than mechanical focal length adjustment system which will prohibit a stealth display as well as improving cosmetic appearance.

Another aspect of this invention is to provide an optical system to reduce chroma-aberration and cross talk of colors which the prior arts suffered very badly. The chroma-aberration and color cross talk are very large because of wide band width of LED light source. These problems will be resolved if a laser light source is used because of its very narrow band width of spectrum. However a laser light source inherently has a severe speckle problem. This invention discloses a system to remove speckle of laser light source within a very compact size enclosure.

Another aspect of this invention is to provide a system to improve the contrast of wearable see-through displays. The image of see-through display will be washed out when a viewer watches images under bright ambient, because a black image does not become dark, but gray or even almost white. This invention adds a layer which reduces the transmission of external light to viewer's eye and discloses how to control the transmission based on the ambient brightness as well as the image locations.

### BRIEF DESCRIPTION OF THE DRAWINGS

FIG. 1 is a cross sectional view of an image display system of prior art shown by Kasai in his published technical report related to U.S. Pat. No. 7,460,286. FIG. 1A is a photo of the actual sample which successfully demonstrated see-though capability.

FIG. 2 and FIG. 2A are shown by Mukawa et al. in SID 2008 Digest, ISSN/008-0966X/08/3901-0089, “A Full Color Eyewear Display using Holographic Planar Waveguides”. The sample wearable display in FIG. 2A successfully demonstrated see-through capability.

FIG. 3 is another example of prior art and reported by Levola at SID 2006 Digest, ISSN0006-64 •SID 06 DIGEST 0966X/06/3701-0064, Novel Diffractive Optical Components for Near to Eye Displays.

FIG. 4 shows another prior art of wearable display with see-through capability having both a display and a camera described in U.S. Pat. No. 7,369,317. FIG. 4A is an example using similar configuration of optics.

FIG. 5 shows an example of this invention. Solid state light sources (116) emit multi-color light beams and the beams are integrated into substantially a single beam by the integrator (101) and focused by a collimation lens (117) and lead to TIR (total internal reflection) prism (114). The beam is reflected by the air gap (118) to the micromirror (106). The light beam will be deflected to (112) when the pixel is ON and deflected to (113) when the pixel is OFF. Prior art micromirror is arranged in the opposite way wherein light is deflected toward the normal direction (113) when pixel is ON and tilted direction (112). 102 is a flexible PCB. 103 is a bump to solder connection. 105 is wiring. 107 is light shield on substrate. 109 is light shield on glass cover. 111 is a hermetic seal.

FIG. 6 illustrates the direction of incoming light beams and outgoing light beams. The plate(014) is a micromirror which is supported by a hinge(015) on the substrate (013). One micromirror is one pixel and when a video signal is ON to the pixel, it will remain flat or tilt in counter clockwise and the incoming light (010) is lead to away(011) from the normal (perpendicular) direction. When the video signal to the pixel is OFF, the micromirror will be tilted in clockwise and the incoming light beam will be deflected substantially toward the normal direction (012).

FIG. 7 shows an example of embodiment of this invention. 116 is a light source(s) and 101 is an integrator to integrate multiple light beams to substantially a single beam. 117 is a collimation lens to focus substantially parallel beam onto the pixel array(l08). 115 is a TIR (total internal reflection) prism which directs the light beam form the light source to the pixel array. 123 is a mirror to reflect the light beam form the pixel array to the waveguide (121). The light beam reflected by the waveguide is reflected by a holographic optical element (HOE, 122) toward viewer's eye (120).

FIG. 8 shows another example of embodiment of this invention. A prism (159) is used to deflect incoming light toward pixel array(l58) instead of TIR as in FIG. 7. A mirror (155) will reflect the light beams from the pixel array(l58) toward the surface(156) of the waveguide. The virtual image (151) of pixel array(l58) is created by the mirror(155) at 151. The virtual image ‘151) is reflected by the surface (156) and its virtual image will be at 152. The virtual image (152) will be lead toward HOE (holographic optical element, 157). The light beams will be reflected to create final virtual image (154). (153) is a virtual image if the HOE does not have focusing power, but only reflection.

FIG. 9 shows a light beam trajectories from a pixel array to HOE. A computer simulation system was developed to design optical systems.

FIG. 10 shows a perspective view of FIG. 9 with 20 degree rotation around the horizontal axis and 35 degree rotation around the vertical axis.

FIG. 11 illustrates the definitions of key parameters. The image of pixel array (123) is created by the optical system prior to the HOE and the HOE receives incoming light as if the object exists at (123). The angle Θr is defined as the angle between the incoming light (136, also called as “Reference Light”) and the normal direction of HOE(143). Θo is defined as the angle between the normal direction of HOE (143) and the light going toward the eye of viewer (142, also called as “Object Light”).

FIG. 12 shows the definitions of angles, when beams are transmitted through HOE. Θ is the angle between the hologram stripe(421) and the reference beam(422) marked R. The light beam(424) marked O is the outgoing light beam after HOE reflects the reference beam “R”. C(423) is a light beam slightly off the beam (422) and dθ is the angle between 422 and 423 with counter clockwise is positive direction. The beam C(423) is deflected by the hologram(420) to the beam I(425). dθ′ is the angle between O(424) and I(425) where counter clockwise is positive direction.

FIG. 13 shows the definitions of angles of reflected beams. The reference beam R(430) enters the hologram(420) and is reflected to the object beam O(432). 434 is the normal direction of the surface of hologram. Θr is defined as the angle between 434 and 430. Θo is defined as the angle between 434 and 433. The beam (431) which is +ΔΘc over R(430) is lead to the hologram (420) and the beam is reflected to I(433) which is −ΔΘi under O(432).

FIG. 14. The side picture shows a regular mirror and its directions of incoming and reflected lights. The right picture shows the incoming light is reflected as if the stripes of hologram works as a mirror. A comparison between a regular mirror and hologram is given. On the mirror, the incident beam is reflected symmetric to the normal direction of the mirror surface. On the hologram, the incident beam is reflected symmetric to the normal direction of the hologram stripes (NOT the surface of hologram film).

In FIG. 15, The stripes of hologram are tilted as a Fresnel concave mirror and HOE works as a concave mirror.

FIG. 16 shows the definitions of beams and angles. The virtual image of pixel array is (135) and the principal beam from a pixel is shown as (136) and diverging light beam is shown as (137). ΔΘc (141) is the divergent angle of beams from a pixel and ΔΘi (140) is the divergent angle of beams from the final image (130). The distance between HOE(122) and the final image(130) is (131). The distance between HOE and the virtual image of pixels array(135) is (132). The distance between HOE (122) and the eye of viewer(138) is (133). 134 is the Eye-Box, where the light from the final image is available.

FIG. 17 shows the definitions of beams and angles. All the definitions are same as FIG. 16 except 130 which is curved because of field curvature aberration.

FIG. 18 shows the definitions of beams and angles. All the definitions are same as FIG. 16 except 135 which is intentionally curved to correct the field curvature aberration.

FIG. 19 shows the definitions of light beams at a flat plate. 146 is an object. 148 is a transparent plate whose refractive index is over 1. 147 is a virtual image location of the object (146) which is shifted by Δ(145).

FIG. 20 shows a method to create a hologram to meet the requirements. (114), (115) and (116) are laser light sources (red, green, blue respectively). 113 is a shutter. 116 is a mirror and 117 and 118 are dichroic mirrors. 119 is a half mirror. 112 is a mirror to direct the laser beam to toward a lens (104) to collimate the beam. 103 is a substantially parallel beam toward the hologram (101). 107 is a mirror to reflect the coherent beam(110) with 103 toward a diverging lens(106) and the beams are lead to concave mirror(106) which emulates the object beams(102) and lead to the hologram(101).

FIG. 21 shows an alternative method to record hologram. The recording beams(102 and 103) are reversed from the method in FIG. 20. If both reference and object beams are reversed simultaneously, the resulting hologram stripes are identical. Therefore, easier method can be chosen All the definitions are same as Fing-20.

FIG. 22 shows another example of embodiment of this invention. All the configurations are identical to FIG. 7 except 114 which is a prism instead of TIR.

FIG. 23 shows another example of embodiment of this invention. All the configurations are identical to FIG. 7 except multiple reflections inside the waveguide(121).

FIG. 24 shows another example of embodiment of this invention. All the configurations are identical to FIG. 7 except the integrator(101) of light source. This example uses a cross prism and light sources are arranged in orthogonal directions.

FIG. 25 shows another example of embodiment of this invention. All the configurations are identical to FIG. 23 except the curved surfaces of waveguide (126,125).

FIG. 26 shows another example of embodiment of this invention. All the configurations are identical to FIG. 23 except the surfaces of waveguide are HOE(129,128).

FIG. 27 shows another example of embodiment of this invention. All the configurations are identical to FIG. 7 except the configuration has no 45 degree mirrors and the light is not bent 90 degrees.

FIG. 28 shows another example of embodiment of this invention. This configuration uses the light beams from the pixel array (145) is in the normal direction using TIR and micromirror. The virtual image of the pixel array is created at 146 and this will cause the differences in the length of path to HOE, which requires a different correction of field curvature.

FIG. 29 shows another example of embodiment of this invention. This shows a micromirror array used as a variable focal length mirror. 160 is a substrate and 163 is a circular sector shaped micromirror having a radial size of 164.

FIG. 30 shows how the micromirror array can work as a concave mirror. Parallel beams are lead to the array and reflected by each mirror and focused onto a single point by adjusting the mirror angles.

FIG. 31 shows a photo of a lamp reflected by a micromirror array. The lamp marked as 161 is the true image of the lamp and all the rest of images except 161 are not real and called as ghost image (162). The ghost images were created by the gaps between mirrors.

FIG. 32 shows a result of computer simulation calculating wave-equation. The result shows a peak (170) representing the true image and some diffraction peaks (171 and 172) at the identical locations to the measured locations(162) of the ghosts.

FIG. 33 shows a result of computer simulation calculating wave-equation with the gaps narrower than wavelength of incident light. It shows only a central peak representing the true image and no or substantially small diffraction peaks showed up. The gap can exist without diffraction peaks if the gaps are smaller than the wavelength of incident light.

FIG. 34 shows another example of embodiment of this invention. When the gap is larger than the wavelength, it is still possible to avoid ghost images coming into the aperture or pupil (169 and marked D) of the optical system. “d” is defined as the diameter of micromirror array(l69) and the diameter of pupil(169) is defined as “D”. The distance between the micromirror array and the pupil is defined as “L”.

FIG. 35 shows the definitions of the size of mirror and the gap between mirrors. The horizontal side is 191 and the horizontal gap is 192. The vertical side is 193 and the vertical gap is 194.

FIG. 36 shows an example of micromirror and the definitions of parameters. A hinge (203) is supporting a mirror (201). The mirror rotates around the middle point of the hinge (203). When the mirror rotates clockwise, the edge of mirror will shift to the right. The distance between the center of rotation and the top of the mirror is defined as 208.

FIG. 37 shows another example of embodiment of this invention. The mirror has multi-layer dielectric (207) which has higher reflectance than 90%.

FIG. 38 shows the diffraction of light by the mirror (400). The incident light is 401 and the reflected light is 402. The virtual image of the incident light reflected by the mirror (400) is 406. It is equivalent to the light wave (406) passing the aperture (405). Besides the main reflection (402), diffracted waves (as 403 and 404) will be created.

FIG. 39 shows the intensity and the angle of the diffracted lights by the mirror (400). The horizontal axis is the angle of outgoing light beam and the vertical axis is the intensity normalized to 1 for the peak. 410 is the peak for the ordinary reflection and 411 is the first order peak of Fraunhofer diffraction. The angle of diffraction varies as the pitch of mirror and the intensity of diffracted light varies as the gap. If the gap is zero or under the wavelength, the diffraction peak (411) will disappear or substantially low.

FIG. 40A shows another example of embodiment of this invention. The lens 210 is an object lens facing objects and incoming light comes to this lens first. 211 is a mirror array with variable focus and the light after 210 is reflected toward the second micromirror array (212). The light is reflected by 212 and focused onto the image sensor (213).

FIG. 40B shows another example of embodiment of this invention. The lens 215 is multiple lens set to bend the incoming light as an object lens and 214 is a micromirror array and L is the distance from the micromirror array to the pupil whose diameter is D. 215 is the second micromirror to focus onto the image sensor 213.

FIG. 41 shows an equivalent optical model of FIG. 40A adjusted to a wide lens. The lens 215 is an object lens and 216 is an equivalent concave lens of a micromirror adjusted to a convex mirror (211). 217 is an equivalent convex lens of the micromirror adjusted to concave mirror (212). This adjustment of micromirrors will work as a wide lens.

FIG. 42 shows an equivalent optical model of FIG. 40A adjusted to a telephoto lens. The lens 215 is an object lens and 216 is an equivalent convex lens of a micromirror adjusted to a concave mirror (211). 217 is an equivalent concave lens of the micromirror adjusted to convex mirror (212). This adjustment of micromirrors will work as a telephoto lens.

FIG. 44 shows a prior art of speckle remover using a rotating diffuser (41) and a motor (42) and a laser(44) and laser beam(43).

FIG. 44 shows another prior art of speckle remover using laser light sources (11,12,13) and optical fibers (21,22,23). The laser beams are mixed spatially when they are traveling inside the optical fibers after multiple internal reflections. After the mixture of light beams, the beams are focused onto the display device(5).

FIG. 45 shows an example of laser speckle. When a laser beam is scattered to a surface, laser always show this type of random non-uniformity inevitably. This is an inherent characteristic of laser. If the phases of light are randomly different in other words non-coherent, speckle will not show up. If the phases are completely equal, speckle should not show up, but only when the phases are very slightly off, speckle will be created by so called Moire effect.

FIG. 46 shows another example of embodiment of this invention. 182 is the substrate of a speckle remover. 181 is a micromirror and an array of micromirrors are on the substrate (182). 183 is an incident light beam. 185 is the area illuminated by the laser beam. 184 is the outgoing laser beam.

FIG. 47 shows the side view of the speckle remover whose plain view is shown in Fing-46. 183 is an incident laser beam. 181 is a micromirror. 186 is a hinge supporting the mirror. 184 is the outgoing light. 182 is the substrate.

FIG. 48 shows the side view of the speckle remover while the mirrors are moving. The mirror 189 is tilted clockwise and 190 is tilted counter clockwise. Then the beams of incident light are mixed to various directions and the angles of mirrors change by time.

FIG. 48 shows the side view of the speckle remover while the mirrors are moving. The mirror 189 is tilted clockwise and 190 is tilted counter clockwise. Then the beams of incident light are mixed to various directions and the angles of mirrors change by time.

FIG. 49 shows another example of embodiment of this invention.

An image is projected on a see-though eye-glass type display over bright background as the left picture marked prior art has very poor contrast and hard to read. This can be improved by darkening the background as the right picture marked “This invention”.

FIG. 50 shows a typical video signal given to the display device. R stands for Red signal and G for Green and B for Blue.

FIG. 51 shows another example of embodiment of this invention. Besides three primary colors of Red, Green and Blue, the 4^{th} color is added. In this case, the 4^{th} color is UV, but not limited to. A micromirror is capable to change colors fast enough for human eyes not to notice and photo-chromic layer can be added to the eye glass. When UV hits the layer, the area exposed with UV becomes dark.

FIG. 52 shows an example where no darkening is applied.

FIG. 53 shows an example wherein the external scene is ocean and cloud. The super imposed images are two sentences. One is “This is easy to read.” over the darkened area. The other image is “This is not easy to read.” over the area not darkened. The difference is obvious.

FIG. 54 shows an example wherein the external scene is ocean and cloud and the entire image area is darkened.

FIG. 55 shows an example wherein the external scene is ocean and cloud and the entire eye-glass is darkened. The software can control the darkened area and timing as needed.

FIG. 56 shows a typical relation between the voltage applied to micromirror and the angle of mirror rotation. As the voltage increases as in 350, the angle increases up to a certain point(351). Beyond the point (351), the mirror will be pulled in and stops when it hits the stopper(204 of FIG. 36). Further increase of voltage (352) will not change the angle because of the stopper. When the voltage is lowered even below 251, the mirror still stays at the stopper due to stiction and pull in force. At the point 354, the pull-back force by the hinge will overcome the force of stiction and electro-static force and return to the curve 350.

FIG. 57 shows another example of embodiment of this invention. This is an example of analog control of micromirror which does not have stopper, but the configuration of electrodes will not cause pull-in as a digital micromirror. 301 is a mirror. 302 is a hinge. 308 is a via. 303 is a moving electrode connected to the mirror(301) with the via(308). 305 is a stationary electrode.

FIG. 58 shows the side view of FIG. 57.

FIG. 59 shows the plain view of FIG. 57. 303 is a moving electrode which will be pulled toward the stationary electrode (305R), if a voltage is applied between the moving electrode(303) and the stationary electrode (305R).

FIG. 60 shows the side view of FIG. 57, when a voltage is applied between the moving electrode(303) and the right stationary electrode (305R) and the moving electrode (303) is pulled toward 305R and the mirror rotates counter clockwise.

FIG. 61 shows the side view of FIG. 57, when a voltage is applied between the moving electrode(303) and the left stationary electrode (305L) and the moving electrode (303) is pulled toward 305L and the mirror rotates clockwise.

FIG. 62 shows another example of embodiment of this invention. This is an analog micromirror having vertical electrodes whose gap between moving and stationary electrodes is substantially vertical. 303 is a moving electrode and 305 is a stationary electrode.

FIG. 63 shows the side view of FIG. 62.

FIG. 64 shows the side view of FIG. 62, when a voltage is applied between the moving electrode(303) and the left stationary electrode (305L) and the moving electrode (303) is pulled toward 305L and the mirror rotates clockwise.

FIG. 65 shows the side view of FIG. 62, when a voltage is applied between the moving electrode(303) and the right stationary electrode (305R) and the moving electrode (303) is pulled toward 305R and the mirror rotates counter clockwise.

FIG. 66 shows the voltage-angle curve of the micromirrors of this invention. The micromirror shown in FIG. 57 was simulated and the voltage-angle curve was plotted. This showed no hysteresis and very linear relationship between V̂2 and angle, which is much more suitable to control the mirror angle in analog mode.

FIG. 67 shows an example of eye-glass display which can be achieved with this invention. The key characteristics are completely stealth, high resolution, very light and low power consumption.

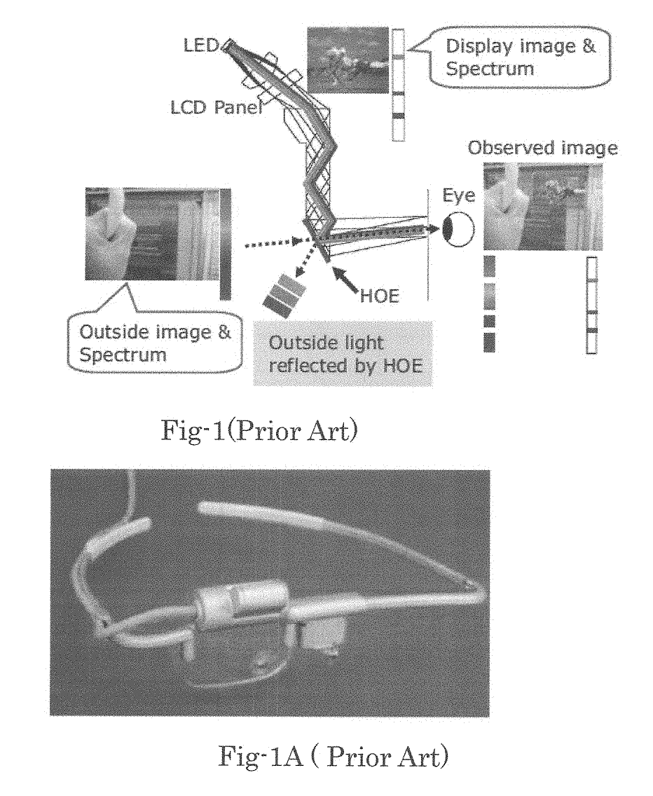

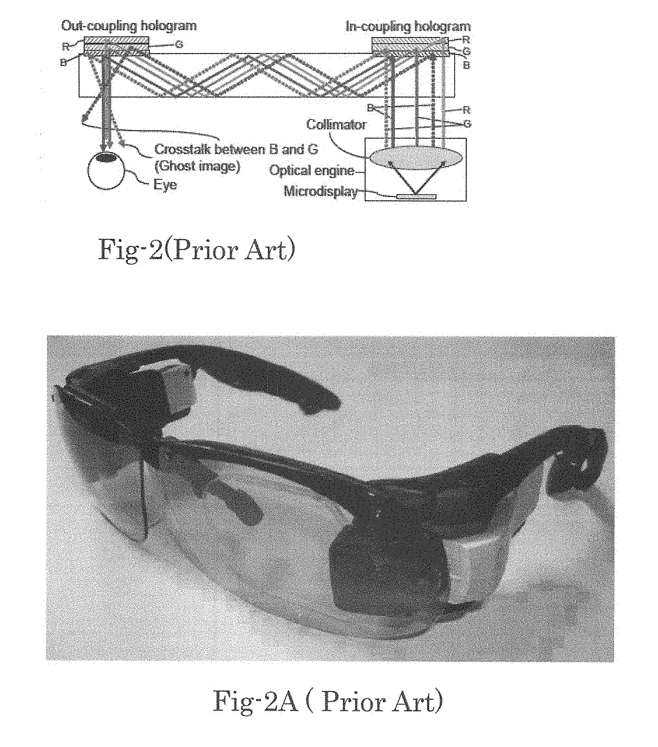

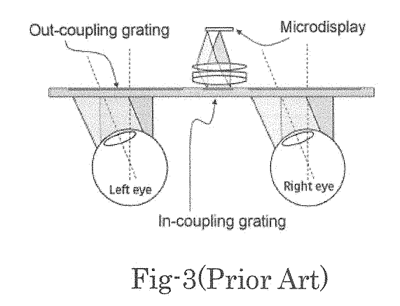

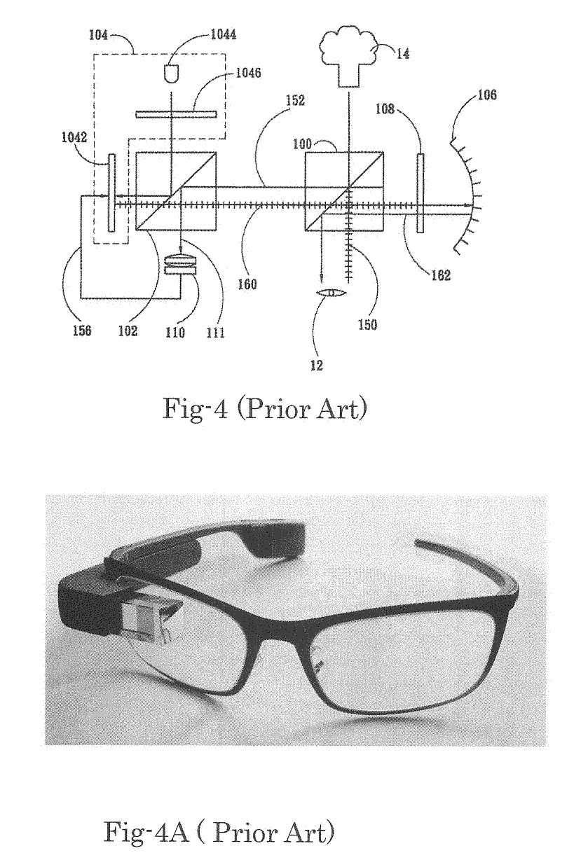

### DETAIL DESCRIPTIONS OF THE PREFERRED EMBODIMENTS

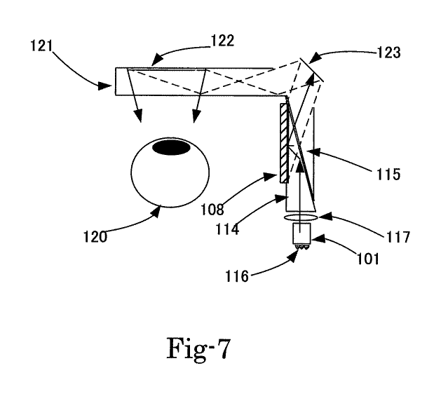

FIG. 5 shows an exemplary embodiment of this invention. A display device 108 is configured by combining a TIR (total internal reflection) 114 with an array of micromirrors 106. The light sources 116 are provided either as a light emitting diode (LED) or as a laser light source. The light source 116 projects lights to an integrator 101 for integrating three light beams and collimated by a collimation lens 117 to project substantially parallel beams. The light beam from the light source 116 is directed to the array of micromirrors 106. The lights are reflected along a light path 112 when the micromirrors are controlled at an ON state or alone light path 113 when the micromirrors are turned to an OFF state according to the incoming video signals. Solid state light sources 116 emit multi-color light beams and the beams are integrated into substantially a single beam by the integrator 101 and focused by a collimation lens 117 and projected to TIR (total internal reflection) prism 114. The beam is reflected by the air gap 118 to the micromirror 106. The light beam will be deflected to a light path 112 when the pixel is ON and deflected to light path 113 when the pixel is OFF. The optical configuration is different from the micromirror as commonly implemented that is arranged in the opposite way wherein light is deflected toward the normal direction 113 when pixel is ON and tilted direction 112. As shown in FIG. 5, 102 is a flexible PCB. 103 is a bump to solder connection. 104 is copper trace, 105 is wiring. 106 is a micromirror. 107 is light shield on substrate. 109 is light shield on glass cover. 111 is a hermetic seal. The outputted beam 112 is guided to a waveguide or a mirror 123 of FIG. 7 to change the direction of light beam as well as changing focal length wherein the mirror 123 is curved or a micromirror having variable focal length adjustability capability. After the light beams are reflected toward the waveguide 121, the beams are reflected by HOE 122 toward the eye of viewer.

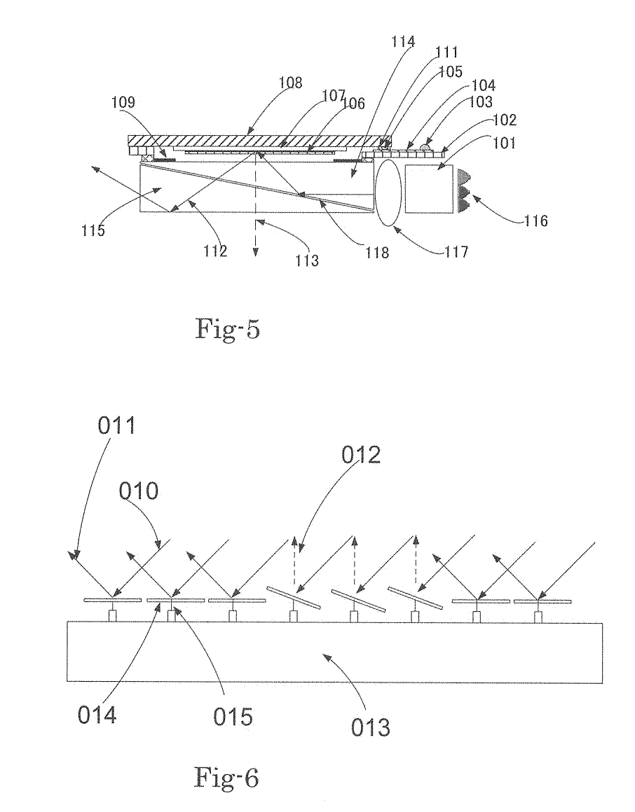

FIG. 6 illustrates the direction of incoming light beams and outgoing light beams. The plate (014) is a micromirror which is supported by a hinge (015) on the substrate (013). One micromirror is one pixel and when a video signal is ON to the pixel, it will remain flat or tilt in counter clockwise and the incoming light(010) is lead to away(011) from the normal (perpendicular) direction. When the video signal to the pixel is OFF, the micromirror will be tilted in clockwise and the incoming light beam will be deflected substantially toward the normal direction (012).

FIG. 7 shows an example of embodiment of this invention. 116 is a light source(s) and 101 is an integrator to integrate multiple light beams to substantially a single beam. 117 is a collimation lens to focus substantially parallel beam onto the pixel array (108). 114 and 115 are a set of TIR (total internal reflection) prism which directs the light beam form the light source to the pixel array. 123 is a mirror to reflect the light beam form the pixel array to the waveguide (121). The light beam reflected by the waveguide is reflected by a holographic optical element, e.g., HOE, 122 toward viewer's eye (120).

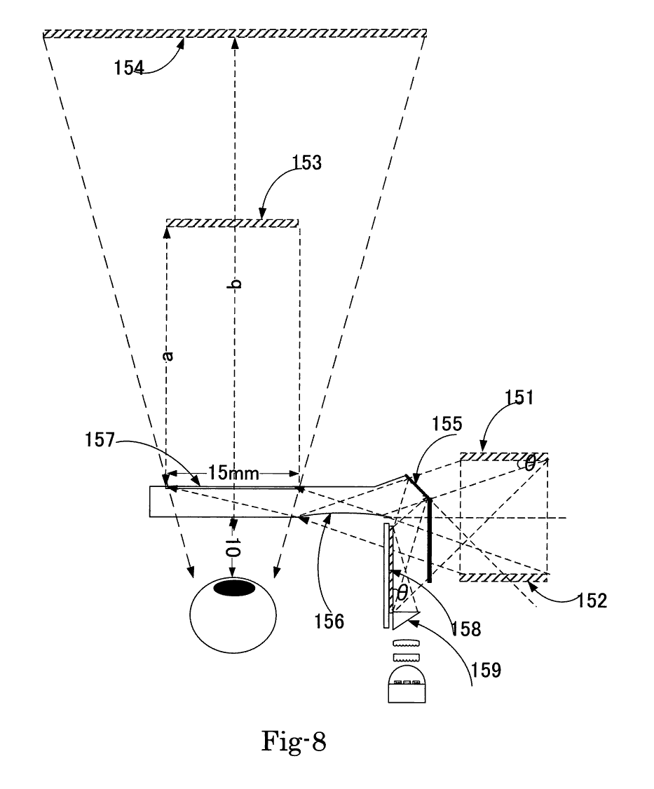

FIG. 8 shown another exemplary embodiment of this invention wherein the light beams are bent toward a display device (158) by a prism (159) instead of TIR (114 and 115 as in FIG. 7) and the display device (158) is placed along the frame of eyeglasses and the tangentially projected image light is led toward a mirror(155) placed in 45 degree angle. The reflected light is led into a wave guide (153) and reflected multiple times as total internal reflection and led toward the eye of viewer by holographic optical element(157). The object of the pixel array of the display device (158) is projected to the mirror(155) and the image (151) is created by reflection. The mirror image of (151) is reflected by the surface (156) of the waveguide(121) and the image of (151) will be created at (152) by mirror effect. The HOE(157) will receive light beams as if light beams are coming from (152). The important characteristics is that the image of object (152) is parallel to the HOE (157). (153) is an image placed at the same distance as 152 for reference purpose.

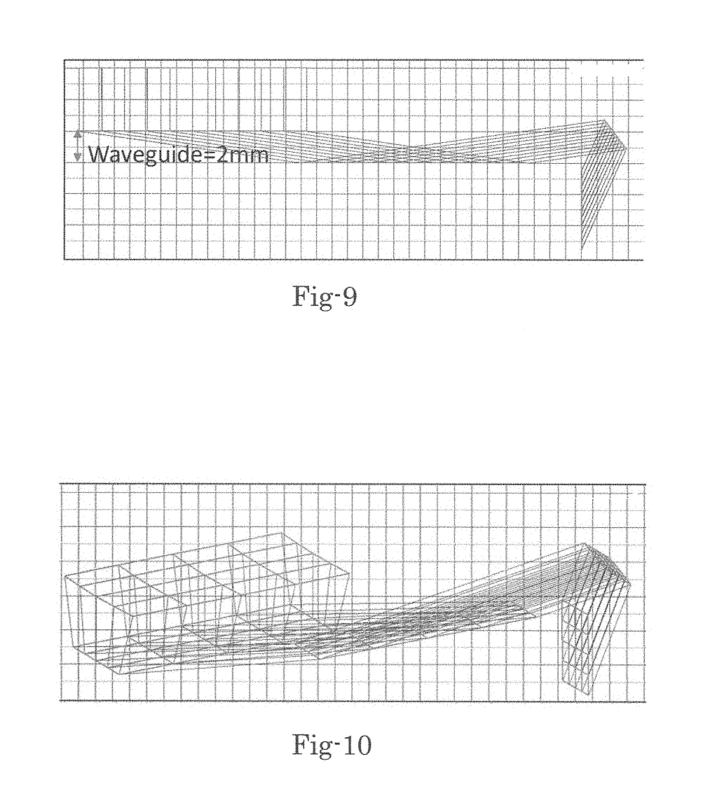

FIG. 9 and FIG. 10 show the results of the simulator which was developed for this development of wearable displays. FIG. 9 shows a plain view of light trajectories from the array of pixels of display device through HOE. After HOE, the light trajectories are intentionally drawn in the reversed direction. FIG. 10 shows a perspective view of trajectories by rotating 20 degrees around the horizontal axis and 35 degrees around the vertical axis.

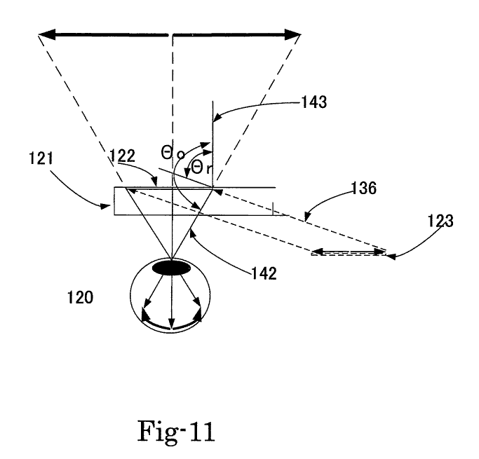

FIG. 11 illustrates the definitions of key parameters. The image of pixel array (123) is created by the optical system prior to the HOE and the HOE receives incoming light as if the object exists at (123). The angle Θr is defined as the angle between the incoming light (136, also called as “Reference Light”) and the normal direction of HOE(143). Θo is defined as the angle between the normal direction of HOE (143) and the light going toward the eye of viewer (142, also called as “Object Light”).

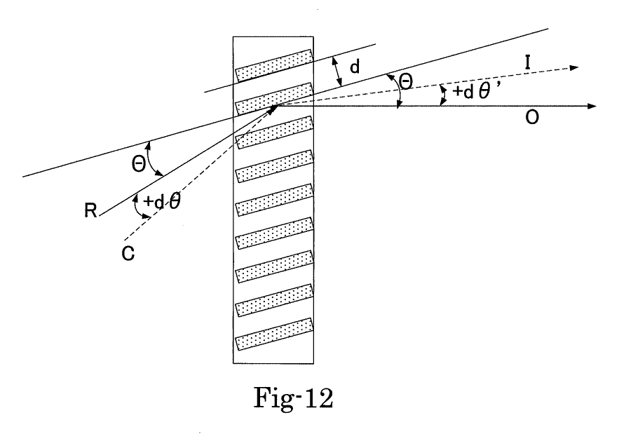

FIG. 12 illustrates how a hologram works in sub-micron level. Hologram consists of a series of stripes(420) whose optical characteristics such as light transmission or refractive index varies cyclically. Θ is the angle between the direction of hologram stripe(421) and the reference beam(422) marked R. The light beam(424) marked O is the outgoing light beam after HOE reflects the reference beam “R”. C(423) is a light beam slightly off the beam (422) and dθ is the angle between 422 and 423 with counter clockwise is positive direction. The beam C(423) is deflected by the hologram(420) to the beam I(425). dθ′ is the angle between O(424) and I(425) where counter clockwise is positive direction. “d” is defined as the pitch of hologram stripes(420) and Θ is defined as the angle between the stripe and the reference beam R. The beam R will be reflected as if the hologram stripe is a mirror and the angle between the outgoing beam O and the hologram stripe is also Θ. The relation between Θ and d is known as Bragg's law.

2d sin(Θ)=nλ (Bragg's law) (1)

n is integral number (+/−1, 2, 3 . . . )
λ is the wavelength of light.

This means that a light beam having the wavelength of λ enters a minute periodical structure at angle of Θ and if Θ meets the above condition, the light beam will be reflected toward the angle of Θ. If the incident beam C(423) is off R(422) by dθ and the deviation of outgoing beam I(425) from O(424) is dθ′, the relation between dθ and dθ′ can be calculated by the following formula(2).

dθ′=cos(Θr)/cos(Θo)×dθ (2)

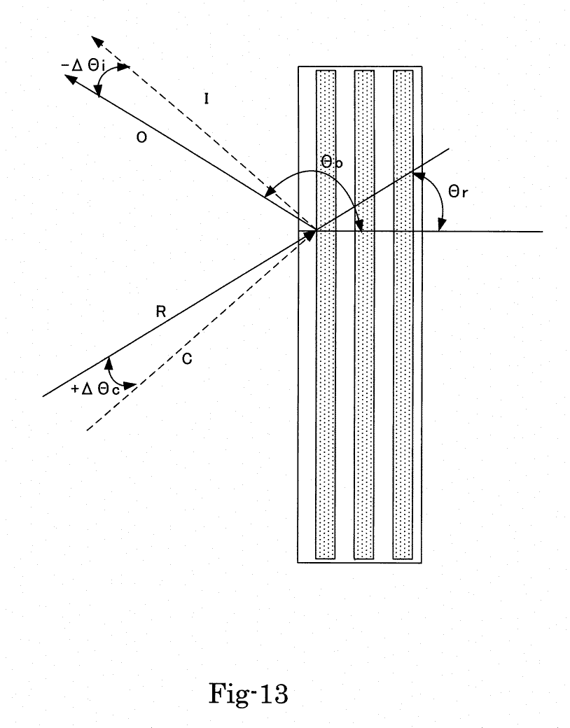

In FIG. 13, the definition of Θr and Θo is given. The reference beam R(430) enters the hologram(420) and is reflected to the object beam O(432). 434 is the normal direction of the surface of hologram. Θr is defined as the angle between 434 and 430. Θo is defined as the angle between 434 and 433. If cos(Θr)/cos(Θo)=−1, the outgoing beam is reflected symmetric to the normal direction of stripes and exactly same as the direction of beam reflected by a regular mirror. This is when the stripe is parallel to the surface of hologram and the hologram reflects a beam same as a mirror. As the direction of stripes moves away from the parallel direction to the surface, the reflected angle is gradually away from the direction by mirror and it affects the location of images. The beam (431) which is +ΔΘc over R(430) is lead to the hologram (420) and the beam is reflected to I(433) which is −ΔΘi under O(432). Ignoring small deviation, a hologram reflects light as if it is a minute mirror stripe. FIG. 15 illustrates an example of hologram which reflects light as a concave mirror. By recording micro stripes in photo polymer in desired directions, any arbitrary reflection angle can be chosen at each location. This is how to make a hologram reflector which can reflect light beams in any desired direction.

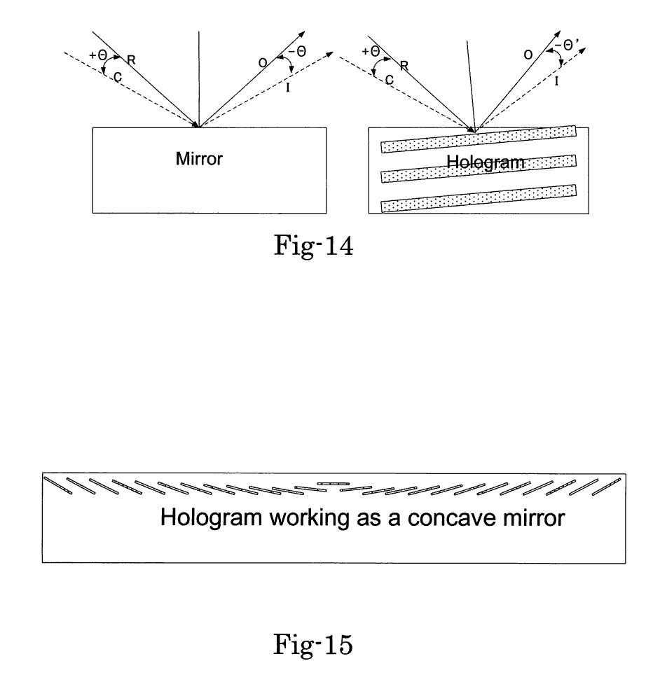

In FIG. 14, a comparison between a regular mirror and hologram is given. In the mirror, incident beam is reflected symmetric to the normal direction of the mirror surface. In the hologram, the incident beam is reflected symmetric to the normal direction of the hologram stripes (NOT the surface of hologram film).

FIG. 15 illustrates an example of hologram which reflects light as if a concave mirror. The directions of hologram stripes are arranged so that parallel beams will be focused to a single point.

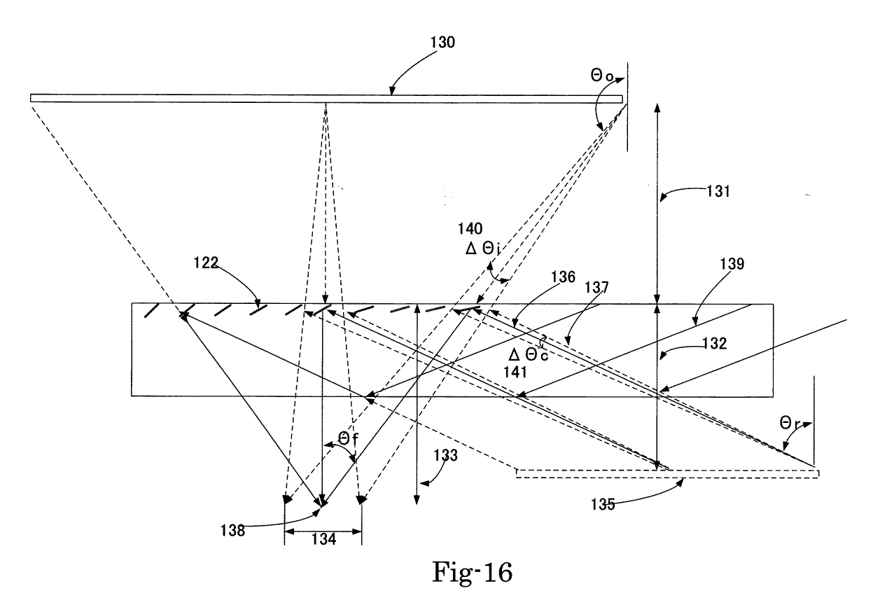

Another example of an embodiment of this invention is shown in FIG. 16, the beam (139) is traveling inside the waveguide and reflected to the hologram (122). (135) is the object of display pixel array. (136) is the principal ray and (137) is a divergent ray from the same source pixel. We can design the hologram so that all the principal rays come to the center of the pupil of the eye of viewer. The diverging beams will be reflected toward the eye with a virtual image at (130). The FOV (field of view) or the viewing angle will be 2Θf and the eye box will be (134). The distance from the hologram to the virtual image can be calculated as the formula below using (1).

i(131)=The distance between the hologram(122) and the virtual image(130)

d(132)=The distance between the hologram(122) and the object image(1306)

e(133)=The distance between the hologram(122) and the center of pupil(138)

Θf−Θo−π (cos(Θf)=−cos(Θo))

1/d=(cos(Θf)/cos(Θr))̂3×(1/i+1/e) (3)

1/i=(cos(Θr)/cos(Θf)̂3×1/d−1/e (4)

If cos(Θf)/cos(Θr)=1 and replacing d with a, i with −b (virtual image) and e with f, this formula is identical to the very familiar lens formula

1/a+1/b=1/f (5)

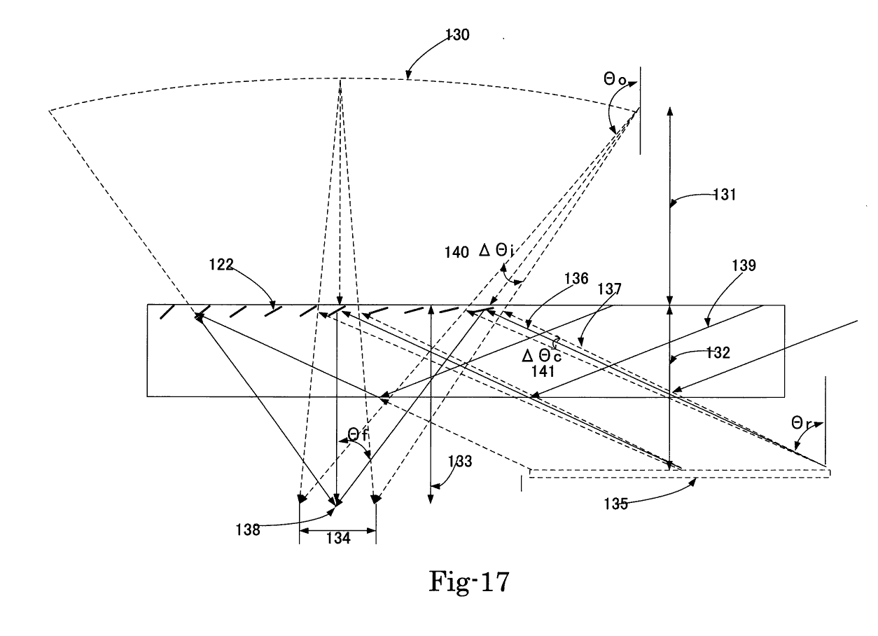

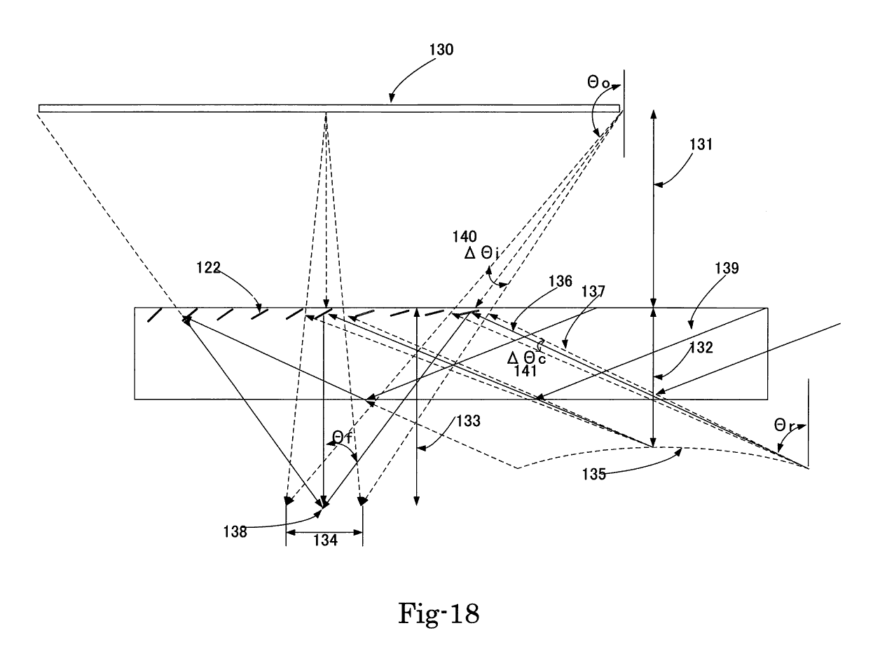

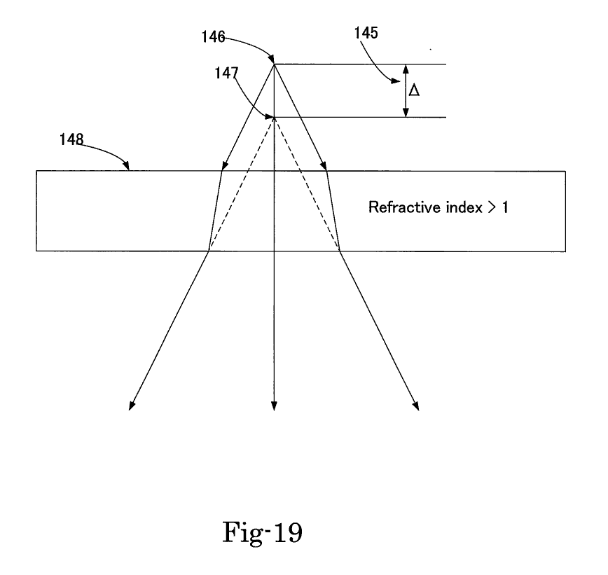

Using (4), the simulated virtual image will be as (130) in FIG. 17 and the virtual image will not be straight, but curved shown in formula (4). The deviation of the distance of image is referred to as “Field Curvature Aberration” and it cannot be compensated electronically and must be corrected optically. The correction is very simple. Using the formula (3), to vary the distance of object, “d” in formula (3) with respect to the angle Θf, assuming both “i” and “e” are constant. The result is shown in FIG. 18 and the virtual image will be straight and flat. This is a method to make virtual image straight and decent to see. We named this method “Cubic Trigonometric Correction”. This formula ignored the image shift by refractive index of waveguide. The shift by refractive index is shown as Δ in FIG. 19. For an actual design this shift has to be adjusted.

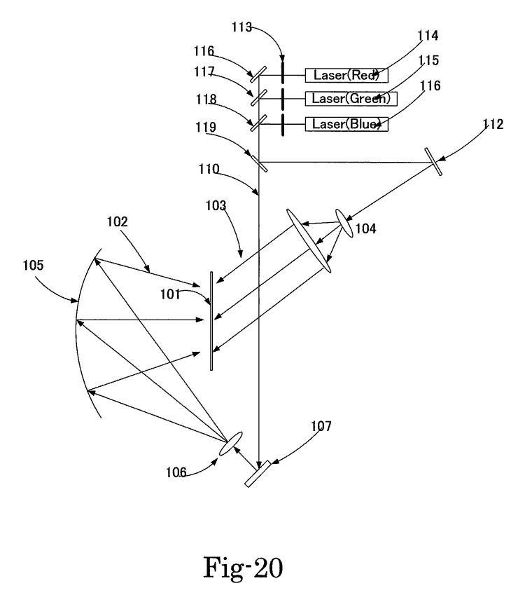

Another example of an embodiment of this invention is shown in FIG. 20, FIG. 20 shows a method to create hologram to reflect the light beams from the display to the center of pupil of eye. Recording of micro stripes of hologram can be achieved by exposing photo-sensitive material such as photo polymer and silver halides with two sets of coherent laser light beams wherein one beam (reference beam) emulates the trajectories of the light beams of the illumination from the display to the hologram and the other beam (object beam) emulates the trajectories of light reflected by the hologram toward the center of pupil. The direction of the stripes will be the middle of the reference beam and the object beam. The exposed photo-film must be fixed. When the hologram is illuminated from the direction same as the reference beam, the light will be reflected to the direction of the object beam, because the direction of the stripes is half angle from the reference beam toward the object beam.

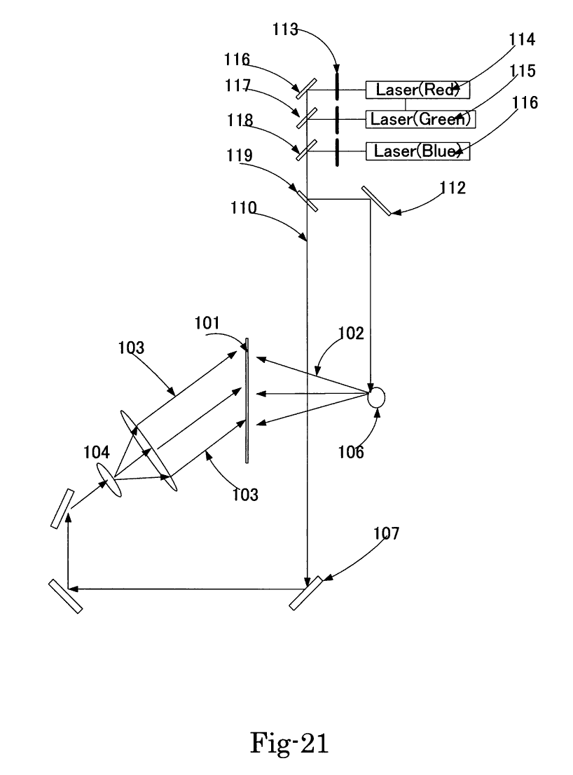

Another example of an embodiment of this invention is shown in FIG. 21, where both reference beam and object beam are reversed from the directions in FIG. 20. Because the direction of micro stripes of hologram is the middle of the reference and the object beams, the direction of hologram stripes will be same as those of FIG. 20.

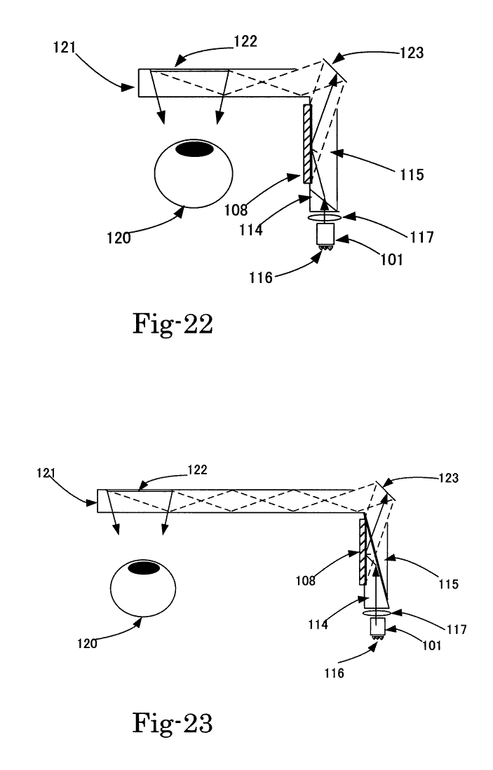

Another example of an embodiment of this invention is shown in FIG. 22 and FIG. 23. FIG. 22 shows a single reflection in the waveguide and FIG. 23 shows an example of multiple-reflection in the waveguide.

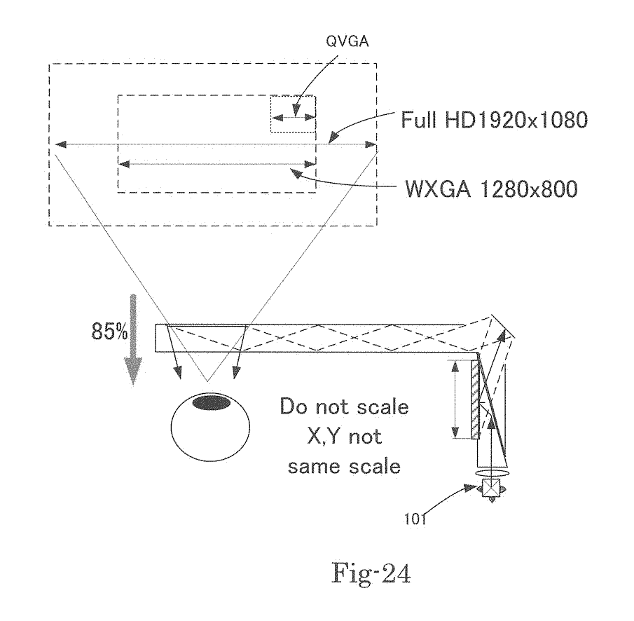

Another example of an embodiment of this invention is shown in FIG. 24. Three light sources are aligned in three orthogonal directions and the three beams are integrated into a single beam with a cross prism.

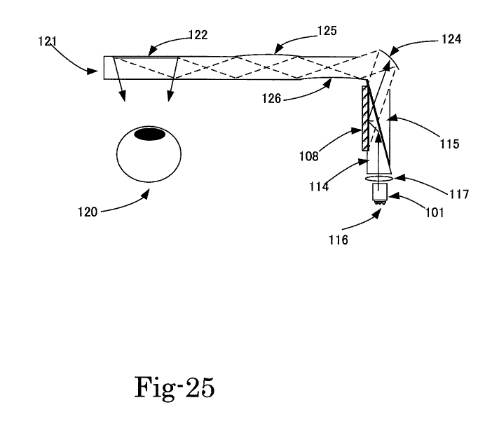

Another example of an embodiment of this invention is shown in FIG. 25. The correction of aberrations such as field curvature described in FIG. 18 can be achieved by applying a curved reflecting surface to one of the first mirror(124), the second reflecting surface (126) and the third reflecting surface(125). The curved reflecting surface can be a free-form mirror (meaning computer generated curvature). The first reflecting mirror (124) can be a variable focal length micromirror for vision control of viewer.

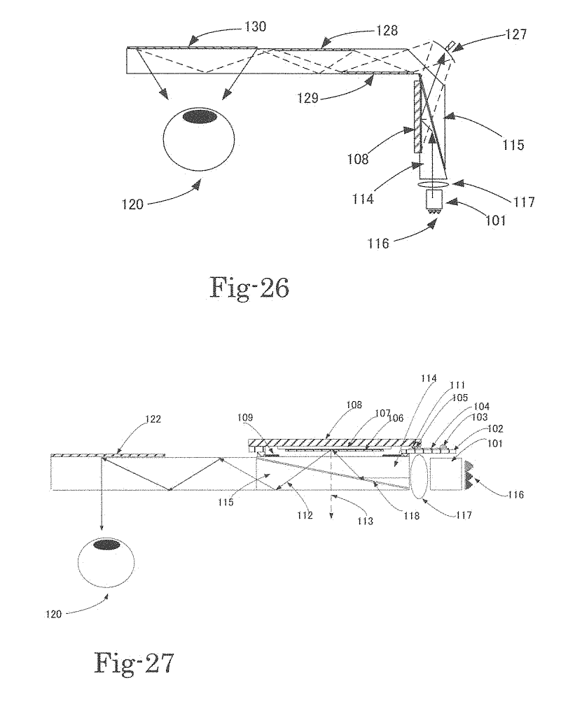

Another example of an embodiment of this invention is shown in FIG. 26. The correction of aberrations such as field curvature can be achieved by applying a hologram to one of the first mirror (127), the second reflecting surface (129) and the third reflecting surface (128). The reflecting surface is a hologram having a distribution of computer generated angles (free-form mirror). The first reflecting mirror can be a mechanically adjustable mirror or hologram for vision control of viewer.

Another example of an embodiment of this invention is shown in FIG. 27. Instead of bending 90 degrees using 45 degree mirror (127), a straight arrangement is also possible as FIG. 27.

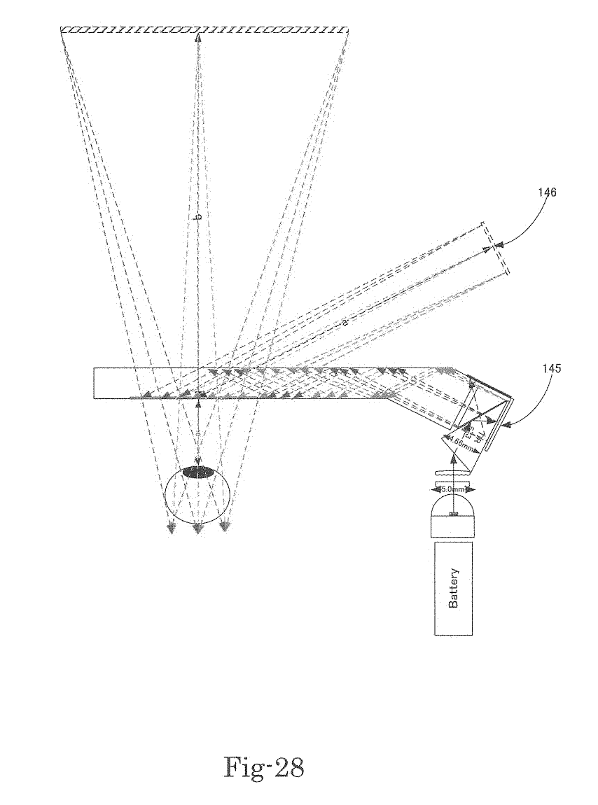

Another example of an embodiment of this invention is shown in FIG. 28. Instead of tangential projection, a normal direction projection is also possible. This arrangement requires a different correction formula, but it can be calculated in the same principle.

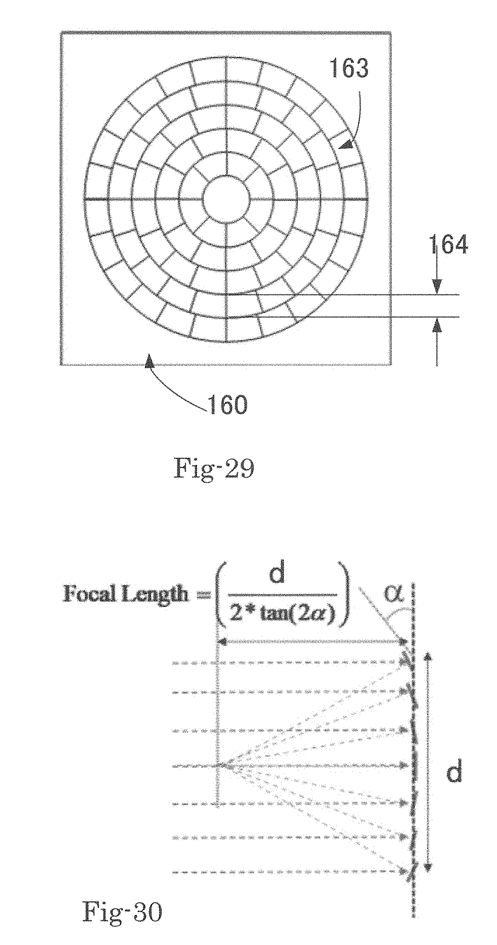

Another example of an embodiment of this invention is shown in FIG. 29, a variable focal length micromirror (160) is placed between the display device and the waveguide for visual control of viewer. If the angles of mirrors are controlled as shown in FIG. 30, the incoming parallel beams will be focused to a single point. This means that this micromirror array works as a concave mirror having focusing power. Because the angles of mirrors are electronically controllable, this can be used as a variable focal length mirror or lens. A flat mirror having various angles with grooves is called Fresnel mirror. So this micromirror array works as a Fresnel mirror with controllable mirror angles. The shape of micromirror can be circular or circular sector (163) as shown in FIG. 29. The pitch of micromirror is shown as (164). Because a micromirror array has gaps between mirrors, they will create Fraunhofer diffraction as well as interference. The diffraction and interference can come into the projected image and worsen the picture quality. A couple of correcting measures are possible. One is to reduce the diffraction and interference by reducing the size of gap. The other method is to avoid the diffraction coming into the aperture (pupil) by adjusting parameters such as the pitch of mirror (164) and the size of aperture, so that the diffracted beams will not come into the aperture. These methods will be described in details in the next paragraphs.

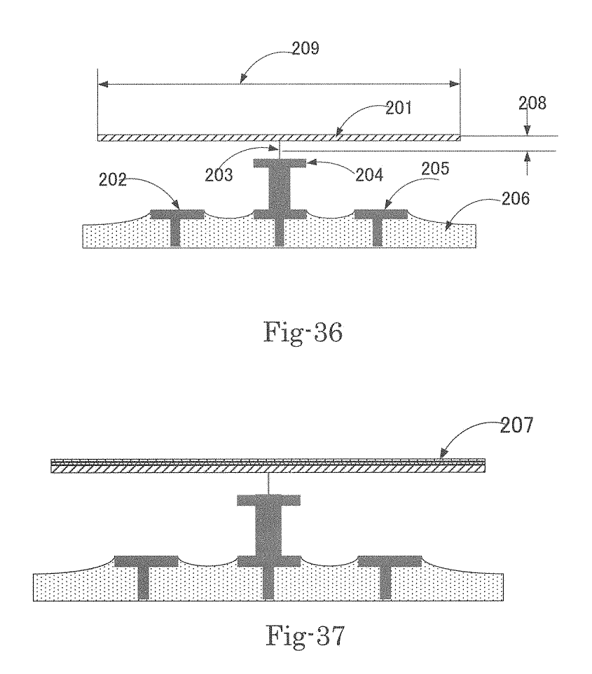

FIG. 31 shows a photo of an image of a lamp reflected by a micromirror array. If the lamp image is reflected by a regular mirror, it shows only (161). But because of the existence of gaps, ghost images (162) showed due to diffraction and interference. The first measure to minimize these ghost images is to reduce the size of gaps. However, there is a reason why we cannot reduce the size of gaps besides the limitations of lithography and etching processes. It is horizontal shift of mirror because of the location of the center of rotation. An example of structure of micromirror is shown in FIG. 36. The center of rotation of mirror is the middle point of hinge (203). When the mirror rotates, the edge of mirror moves around the center of hinge and the edge of mirror moves vertically as well as horizontally which reduces the gap between mirrors. To reduce the size of gap requires to reduce the distance (208) between the middle point of hinge and the top of mirror. An intensive study and simulation of diffraction and interference revealed that the intensity of diffracted beams will be substantially reduced if the gap (192 and 194) is smaller than the wavelength of incoming light. Δ is defined as the horizontal shift of mirror and the gap will be reduced by 2Δ, when two adjacent mirrors shifted closer. To avoid collision of mirrors, 2Δ must be smaller than the wavelength of incoming light λ.

2Δ<λ (6)

2Δ=2d̂2/D<λ (7)
d=The distance (208) between the middle point of hinge and the top of mirror
D=the size of mirror perpendicular to the rotation angle

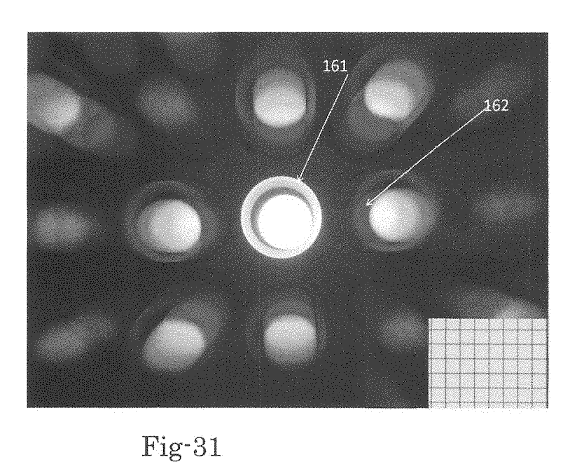

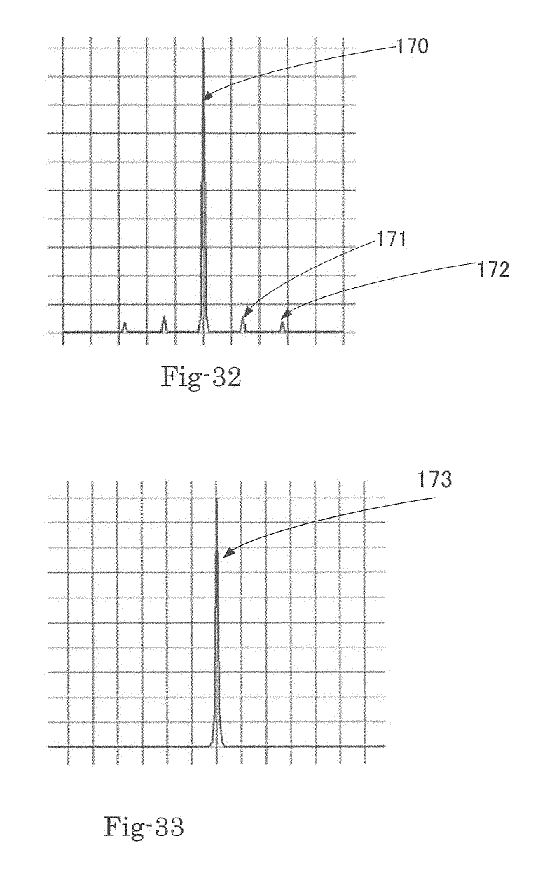

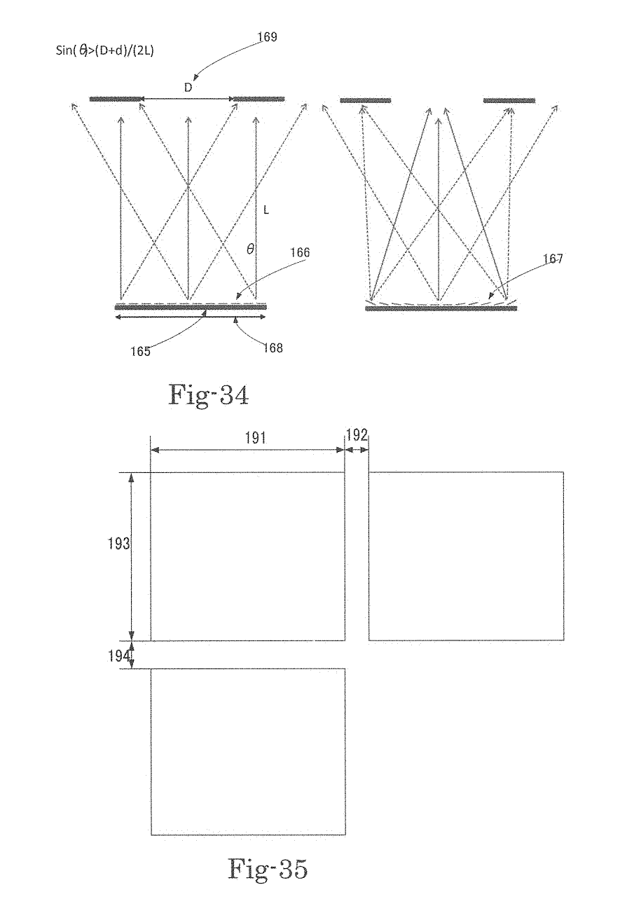

Another example of an embodiment of this invention is shown in FIG. 34 to implement the second measure to avoid diffraction and interference from micromirror. The angle of the first order peak (171 in FIG. 32) of diffraction is shown in the formula (12) below. If the first peak (171) is out of the pupil or aperture (169 in FIG. 34), the ghost images can be avoided.

The angle of Fraunhofer diffraction can be shown in the following formula.
θ=the angle of Fraunhofer diffraction (vertical)
φ=the angle of Fraunhofer diffraction (horizontal)
λ=the wave length of light
W=the size of mirror (horizontal, 192 in FIG. 35)
H=the size of mirror (vertical, 194 in FIG. 35 or radial direction, 164 in FIG. 29)
I(θ, φ)=the intensity of reflected light from a rectangular mirror toward the angle θ and φ

I(θ,φ)∝sinĉ2(πW sin(φ)/λ)×sinĉ2(πH sin(θ)/λ), wherein sinc(x)=sin(x)/x (8)

I(θ, φ) has local peaks at θ=0 and πH sin(θ)/λ=+/−(n+½)π, where n is a natural number (n>=1) and the same for φ.

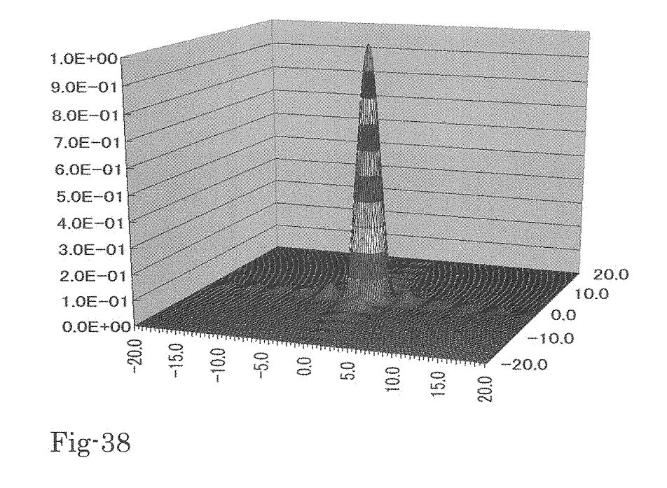

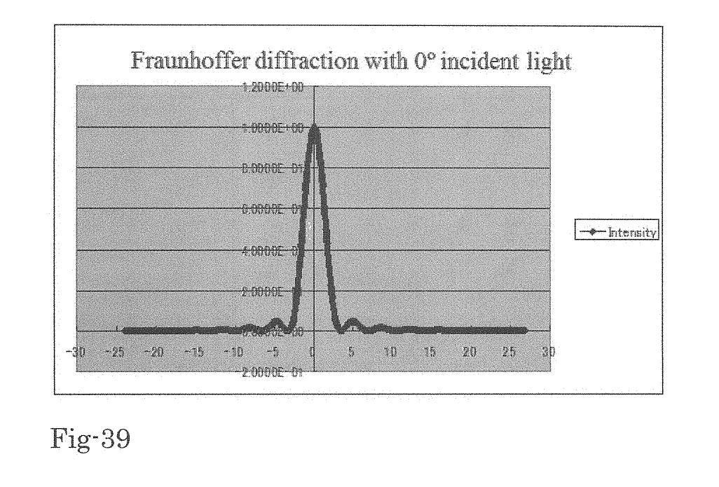

The shape of I(θ, φ) is shown in FIG. 38 and FIG. 39. The first peak will be at

θ=a sin(3/2λ/H) (9)

φ=a sin(3/2λ/W), (11)

where a sin is arc-sine and it can be approximated to

θ=3/2λ/H=1.5λ/H (radian) or 1.5λ/H×180/π(degrees) (12)

The light reflected toward 0 degrees is the true image of object and the reflected lights over θ=3/2λ/H are ghost images. To avoid the ghost images, we can design the system so that all the diffracted light beams are diverted out of the pupil in the next path. To do so, we can apply the following formula.

D=the diameter of the pupil (or aperture) in the path.

L=the distance from micromirror to the pupil in the optical path.

W<3/2λL/D and H<3/2λL/D (this is the formula to avoid ghost images.) (13)

Adding to consider the size of micromirror and sin(θ) is close to tan(θ), but slightly smaller than tan(θ), it should be sufficient to meet the following condition to avoid the first order peak of diffraction entering into the aperture of D as shown in Fing-35, if W and H<3λL/(d+D) and

W and H<3λL/(d+D) (this is the formula to avoid ghost images.) (14)

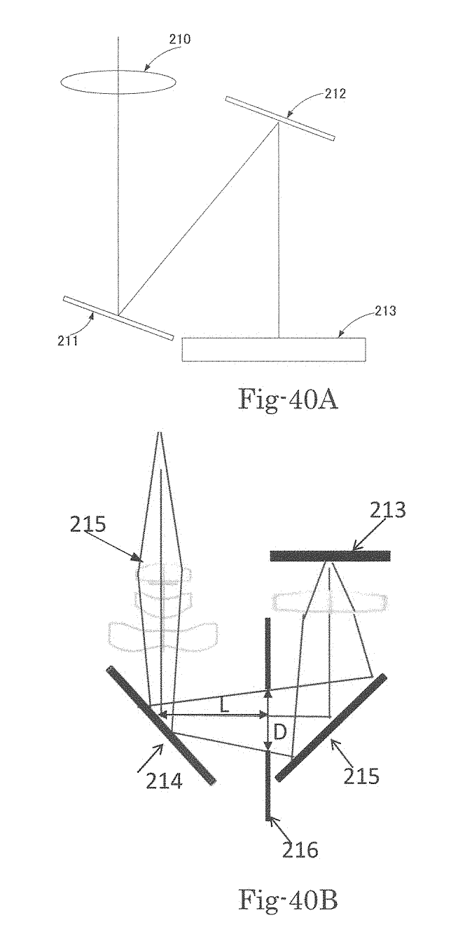

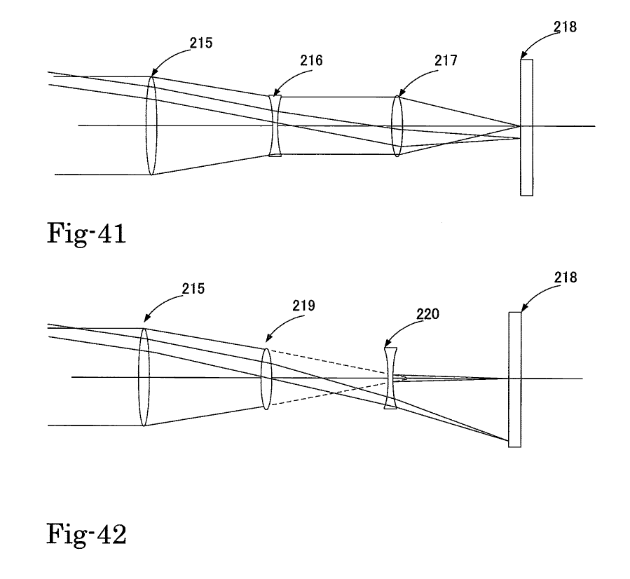

Another example of an embodiment of this invention is shown in FIG. 40A. (210) is a set of lens of camera. (211) and (212) are micromirror arrays having variable focal length capability. (213) is an image sensor such as CCD and CMOS imager. This module from 210 through 213 can work as a camera having optical zooming capability. When the first micromirror acts as a convex mirror equivalent to a concave lens(216) and the second micromirror acts as a concave mirror equivalent to a convex lens(217), the total effect is a wide angle lens as shown in FIG. 41. When the first micromirror acts as a concave mirror equivalent to a convex lens(219) and the second micromirror acts as a convex mirror equivalent to a concave lens(220), the total effect is a wide angle lens as shown in FIG. 42. This module can be made small enough to fit in a mobile phone. FIG. 40B shows another example of an optical zooming system, wherein the optical paths are arranged in U shape.

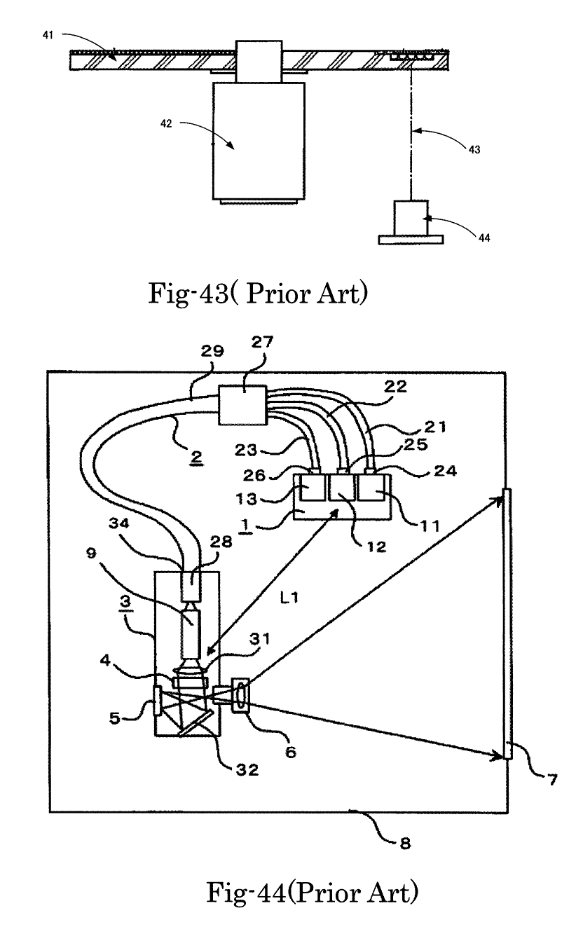

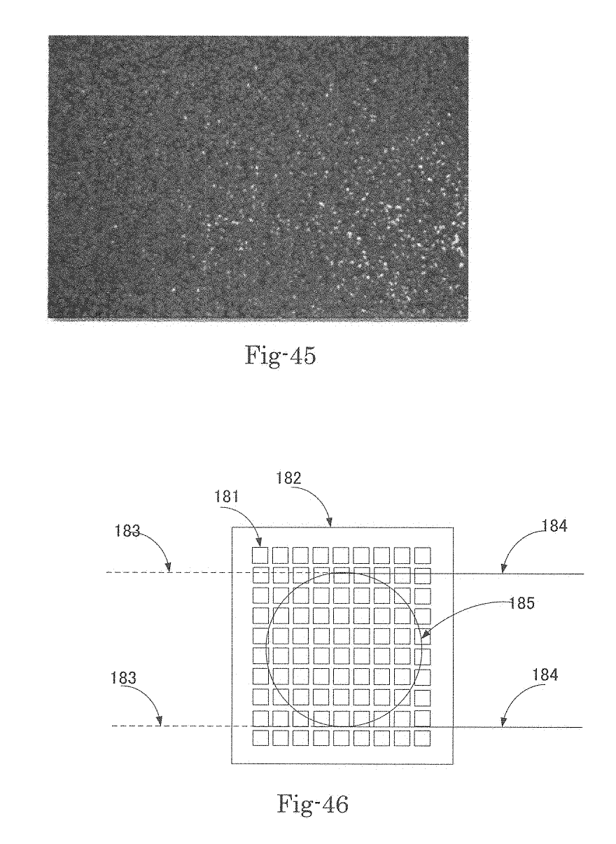

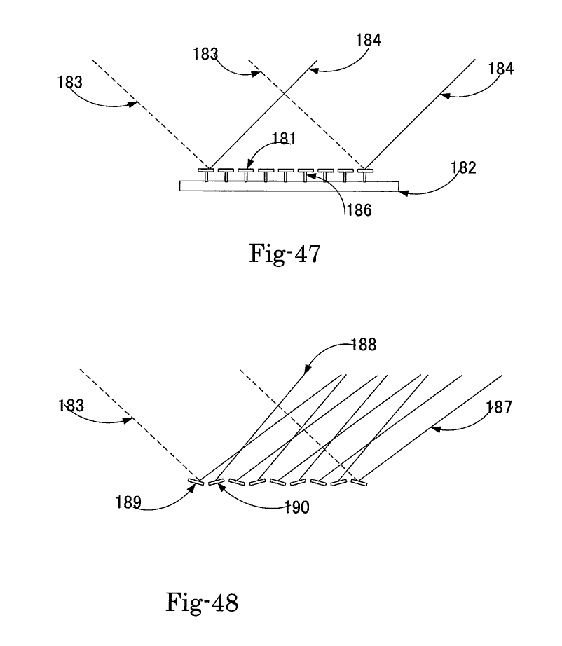

Another example of an embodiment of this invention is shown in FIG. 46 through FIG. 48. To utilize a laser light source, it is inevitable to reduce or eliminate speckle of laser, because speckle is inherent to laser light source. To reduce or eliminate speckle requires to mix light spatially or temporally or both spatially and temporally. Good result is usually obtained when both spatial and temporal mixing is conducted. A prior art is shown in FIG. 43. This system consist of a rotating disc of diffuser and a motor to rotate it and laser light source which pass through the moving diffuser. This type of speckle reducer is successfully commercialized, but it is big and costly and also has a reliability issue because of moving parts. Another example of prior art is shown in FIG. 44, which uses optical fibers to mix laser beams spatially. This can be used without moving parts, but the length of the optical fibers can be as large as 2 meters. It is costly and not suitable for the use in a mobile application. FIG. 46 shows an array of micromirrors whose mirrors can be driven in at least two different directions independently or as a group. (183) is an incident laser beam and (184) is an outgoing beam. If micromirrors are driven faster than the human eye's flicker speed in various direction as shown in FIG. 48, the incident laser beams will be mixed spatially and temporally to eliminate speckle. This speckle remover is very low cost as well as very small suitable to fit in a mobile device.

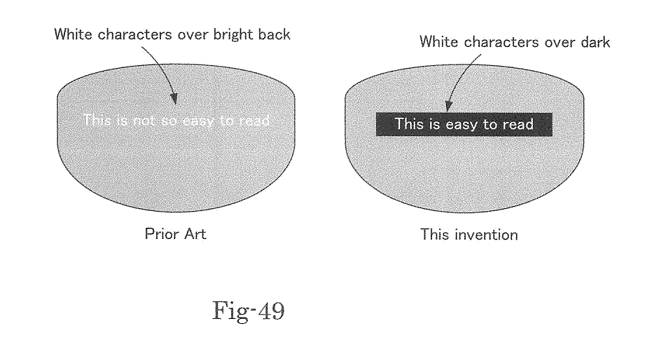

Another example of an embodiment of this invention is shown in FIG. 49. When a see-though type of display is used under bright ambient such as Sunlight, the contrast of image is very much degraded or even not visible. FIG. 49 exemplifies how difficult to read characters with bright background comparing with dark background. To improve this problem, it is necessary to block or reduce the incoming light. This invention discloses several methods to control the level of block by ambient brightness as well as by the incoming video signals. The background brightness can be controlled with a photo-chromic layer as a UV sensitive Sunglasses. When UV is present, the transmission of external light will be reduced. Another method is to use an electro-chromic layer. Sensing the brightness and controlling the light transmission is possible with an electro-chromic layer.

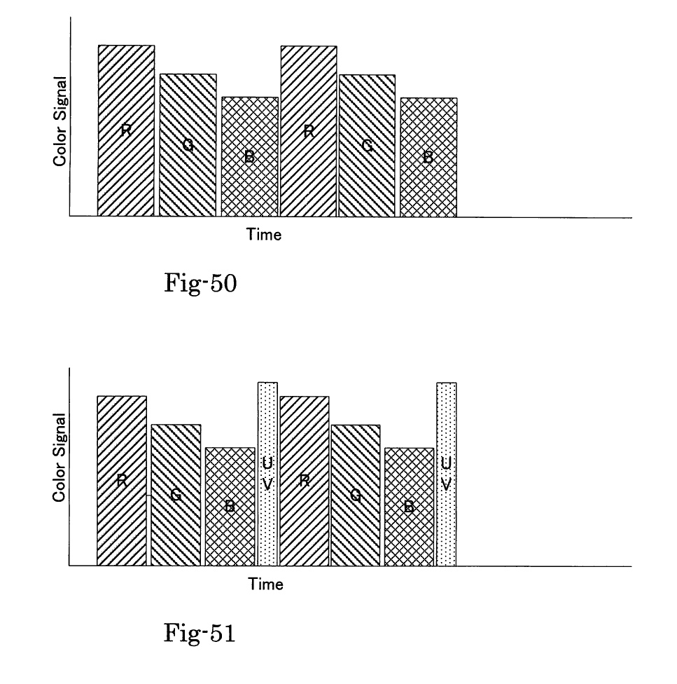

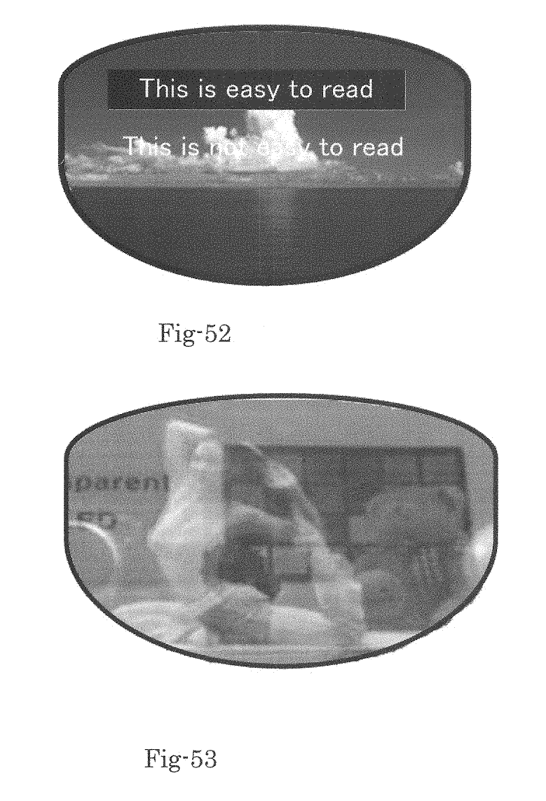

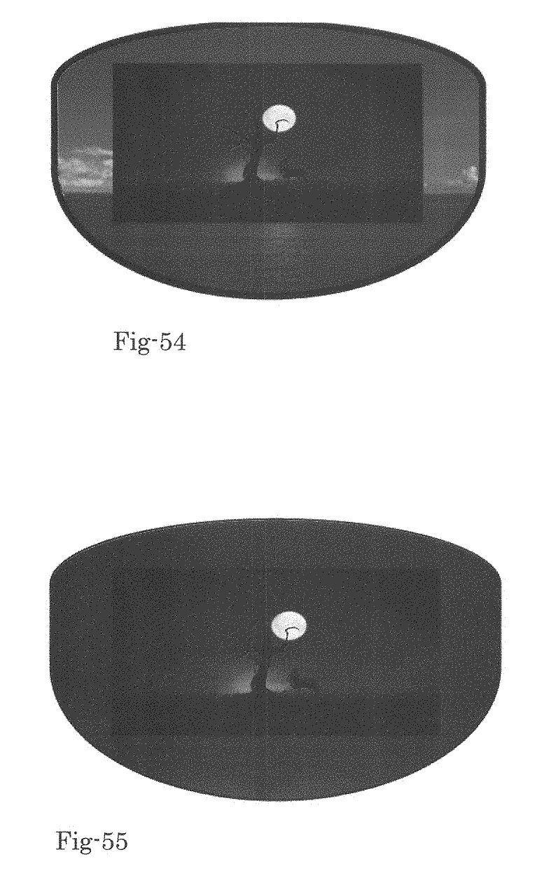

Another example of an embodiment of this invention is shown in FIG. 51. A typical color sequential display is driven as FIG. 50 wherein a single color is displayed at a time and color is changed sequentially. Some applications use more than three visible colors. By adding UV light or any light which activates a photo-chromic layer, it enables to block external light and improves contrast. This method provides a freedom to choose the location of dark background and FIG. 52 is an example to darken only one line of sentence. FIG. 53 has no place darkened and FIG. 54 darkened the display area and FIG. 55 darkened the entire glass.

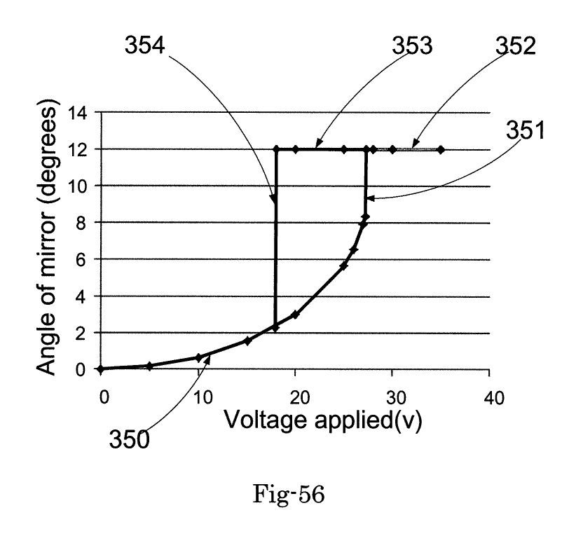

FIG. 56 shows the characteristics between voltage and rotation angle of mirror for a typical digital micromirror shown as in FIG. 36. When voltage is applied between the electrode (205) and mirror (201), the mirror (201) will rotates in clockwise due to electro-static force. The relation between the angle and voltage is shown in FIG. 56 which represents an actual measurement. As voltage increases, the angle will increase as (35). When the voltage is increased to a certain point (351), the mirror will be pulled in toward the electrode and stops when it hits the stopper(204). Further increase of voltage(352) will not increase the angle because of the stopper(204). When the voltage is decreased along (352), the angle will not change because the mirror contacts and sticks to the stopper(204) even below the pull-in angle (351) until (354). When the voltage is below (354), the mirror suddenly pulled back away from the stopper(204) and comes down to the original curve (350). As this, a digital micromirror has a hysteresis. For analog application such as variable focus and zooming system, this hysteresis is undesirable. We prefer to have an analog micromirror without hysteresis, so that the rotation angle can be controlled to any desired angle in analog mode.

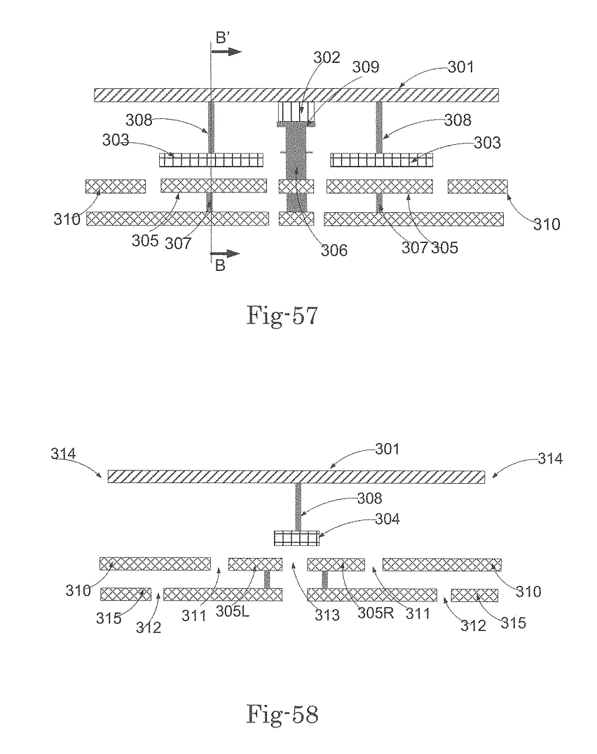

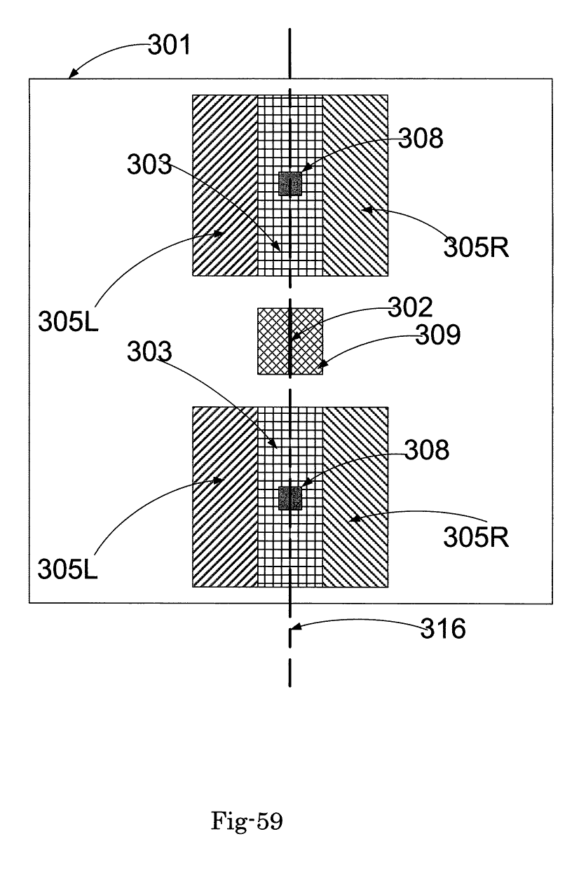

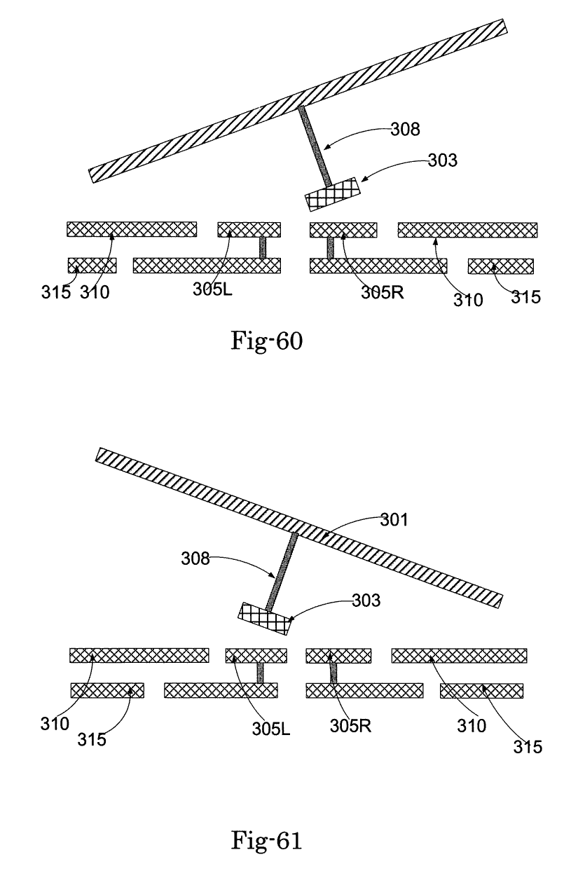

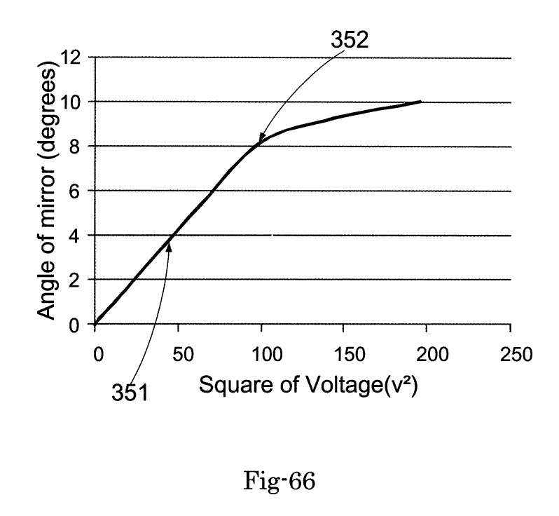

Another example of an embodiment of this invention is shown in FIG. 57(Front view), which embodies an analog micromirror. Taking the advantage of vertical hinge, the central areas besides the hinge(302) and hinge base(306) are open and we can place moving electrodes (303) and stationary electrodes(305). At the neutral position at the center line(316) where the mirror rotation angle is zero as shown in FIG. 59 (Plain view), there is enough room to place moving electrodes (303) and stationary electrodes(305). FIG. 58 shows a side view of the system. At the neutral position of zero angle, the moving electrode(303) has no or little overlapping area with the stationary electrode(305R and 305L). If voltage is applied between the moving electrode(308) and the stationary electrode(303), the moving electrode(308) will be pulled toward the stationary electrode(303) due to electro-static force and the overlapping area will increase as the voltage is increased as shown in FIG. 60. However when the overlapping area reaches the maximum, no further force will be generated and the mirror rotation will stop. The relation between voltage and angle is shown in FIG. 66, which is the result of simulation based on the design of FIGS. 57, 58 and 59. This result shows clearly that there is no hysteresis and it can be controlled linearly up to the point (352). In this arrangement, the gap is horizontal.

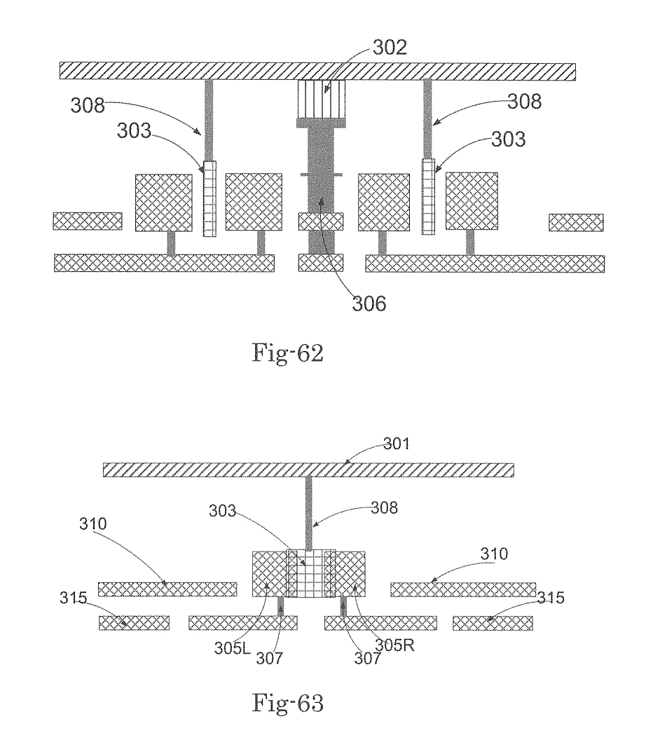

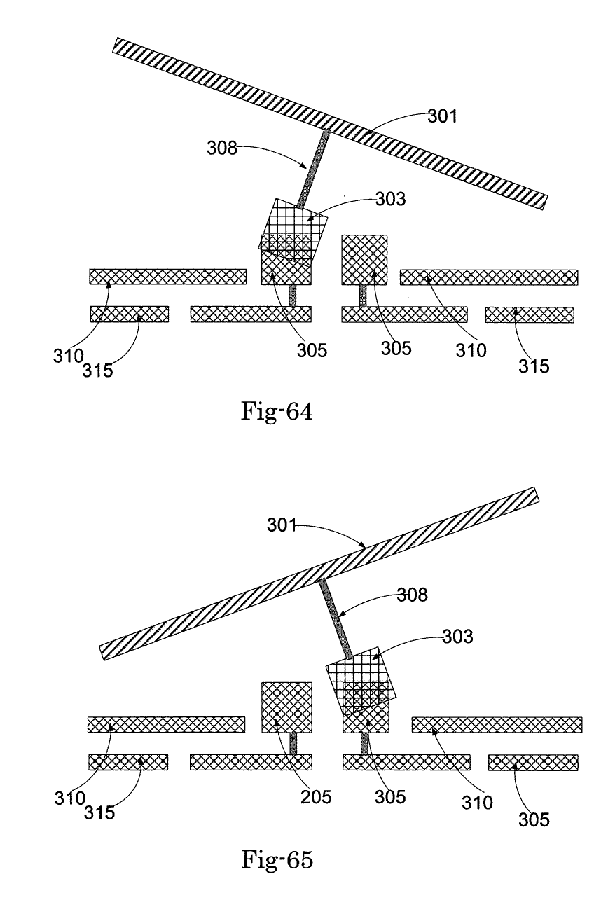

Another example of an embodiment of this invention is shown in FIG. 62(Front view) and FIG. 63 (side view). The moving electrodes and the stationary electrodes are vertically arranged and the gap is vertical.

Another example of an embodiment of this invention is to use a memory to adjust the rotation angle with calibration data. With the present accuracy and repeatability of processes, it may not be possible to control the rotation angle with the accuracy necessary for focal length adjustment and/or zooming control. It is possible to measure the relation between voltage and angle and to calibrate the angle with the memorized voltage to angle relations.

Another example of an embodiment of this invention is to compensate diffraction noises mathematically using memorized image and the estimated noise from a peak of signals can be subtracted, so that the ghost images can be eliminated.

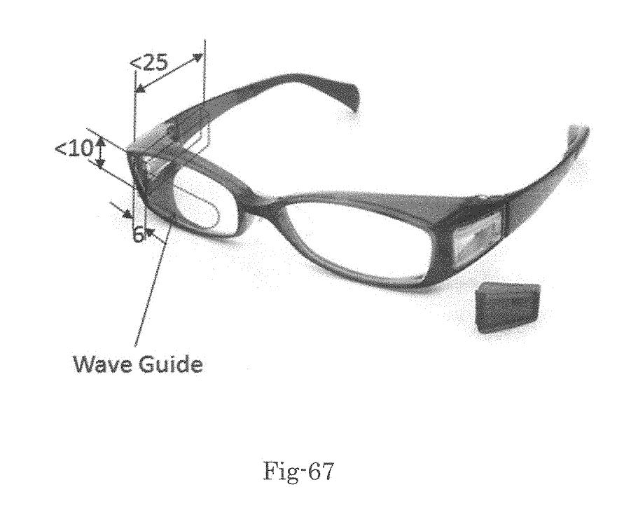

FIG. 67 exemplifies a pair of glasses which incorporates the inventions disclosed in this application. The image is completely hidden so that the image is not visible at all from the front or from the side or from the backward except the eye-box. The display unit can fit in less than 6 mm thick 10 mm high and 25 mm long frame. The display can show over 1 million pixels and visible even under Sunlight.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A display system comprising:
A spatial light modulator (SLM) and
The outgoing light containing image is projected substantially away from the normal (perpendicular) direction of the surface of said SLM and
A waveguide passing the projected light with total internal reflection (TIR) and
at least an optical element from a group of holographic optical element and diffractive optical element to guide the image light toward a viewer.

2. The display system of claim 1 wherein:
Said spatial light modulator is one from a group of micromirror having the mirror angle substantially parallel to the substrate at ON state and reflective type LCD.

3. The display system of claim 1 wherein:
There is an optical element having a free-form surface correcting field curvature aberration using cubic trigonometric function of the angle of a beam from the holographic element to the eye of viewer.

4. The display system of claim 1 wherein:
There is an additional holographic optical element to correct field curvature aberration using cubic trigonometric function of the angle of a beam from the holographic element to the eye of viewer.

5. An optical system comprising:
An variable focal length Fresnel micromirror having multiple elements of light reflecting micromirrors whose angle can be controlled electro-statically in analog mode and independently at least for groups of micromirrors so that desired optical characteristics including a concave mirror, convex mirror, aspherical mirror and a Fresnel mirror with free-form curvature can be achieved and
Hidden hinges attached to the mirrors are located under the mirrors and
Flat surface of mirrors without hole, line, protrusion and any optically visible marks and
A supporting structures of mirror are ground and polished to have said flat surface before depositing mirror material.

6. The optical system of claim 5 wherein:
The gaps between micromirrors are smaller than the wavelength of incoming light.

7. The optical system of claim 5 wherein:
The size of larger side of rectangular micromirror and the size in radial direction of circular and circular sector of micromirror is less than 3λL/(d+D) wherein λ is the wavelength of incoming light and L is the distance between micromirror and aperture and D is the diameter of aperture and d is the diameter of micromirror, so that the first order peak of diffraction does not come into the aperture to avoid ghost images.

8. The optical system of claim 5 wherein:
The optical system is a display including wearable display, head-up-display, head-mount-display, face-mount-display and see-through display and the visual control to adjust to the eyes of viewer including focus, near sighted, far-sighted and senior vision and the micromirror has mirror elements which are circular or circular sectors so that said micromirror can function as a Fresnel mirror with variable angle in analog mode.

9. The optical system of claim 5 wherein:
The optical system is a camera with electronically adjustable focal length using micromirrors whose mirror elements are circular or circular sectors so that said micromirror can function as a Fresnel mirror with variable angle in analog mode.

10. The optical system of claim 9 wherein:
The optical system has at least two micromirror arrays having variable focal length capability so that the system can zoom and focus on an object.

11. The optical system of claim 5 wherein:
The optical system is a projection display including viewfinder, wearable display, see-through display and Pico-projector having electronically controllable focus and electronically adjustable aberration correction with analog micromirror system.

12. A display system comprising:
A spatial light modulator and
laser light source(s) and
a speckle remover(s) comprising:
a mirror array having multiple mirror elements on a substrate;
each element comprising a mirror supported on a hinge;
each mirror has at least one electrode and said mirror is deflectable electro-statically;
incoming coherent light lead to the surface of said mirror array;
said incoming coherent light is divided into multiple minute beams;
said beams are reflected to multiple directions by said mirrors;
said beams are mixed spatially and temporally to reduce speckle.

13. The display system of claim 12 wherein:
The spatial light modulator is from a group of micromirror, LCD, LCOS and MEMS shutter device.

14. The display system of claim 12 wherein:
There is a backlight using laser light sources and polarized laser light from said light source is guided through zero birefringent film and lead to display without polarizer to increase the brightness of the display by eliminating the polarizer.

15. The display system of claim 12 wherein:
The display is a wearable display having light source(s) from a group of laser, LED, phosphor activated by laser and laser with second-harmonic-generation.

16. A see-through display system comprising
A spatial light modulator (SLM) and
Waveguide wherein image light from said SLM goes through and
Optical element from a group of holographic optical element (HOE) and diffractive optical element (DOE) to direct image light toward the eye of viewer and
A layer from a group of photo-chromic, electro-chromic and LCD so that the transmission of external light to the eye of viewer will be reduced under bright ambient to improve the contrast of image.

17. A display system comprising:
A spatial light modulator (SLM) and
A set of light sources having at least two colors and
A control system to drive said SLM and said light sources and
A set of optics enabling see-through capability by superimposing the projected image by said SLM on external scene and
means to block the incoming light from the external scene to viewer wherein the level of blocking intensity and the area of block can be controlled by said control system.

18. The display system of claim 17 wherein:
Said means is from a group of photo-chromic layer, electro-chromic layer and LCD.

19. The display system of claim 17 wherein:
Said control system provides video signals of at least three primary colors and signal representing black.

20. The display system of claim 17 wherein:
UV protective film is attached to protect viewer's eyes.

21. The optical system of claim 5 wherein:
The system has a set of memories to memorize the voltage suitable for each pixel and the system can provide said suitable voltage to each pixel and the suitable voltage for each pixel can be measured by applying light beam and the reflected light beam is measure by an image sensor.

22. The optical system of claim 5 wherein:
The incoming image signal is compensated mathematically using known relation between peak and diffraction noise, so that the residual diffraction noises are reduced or eliminated.

23. The optical system of claim 5 wherein:
Said micromirror comprises
moving electrode(s) connected to the mirror located substantially under the center line of rotation axis of mirror and
stationary electrode(s) connected to the substrate located adjacent to the moving electrode(s) with a gap and
the overlapping area between said moving electrode(s) and said stationary electrode(s) will increase as the mirror rotates up to an angle and the overlapping area will decrease beyond said angle.

24. The optical system of claim 5 wherein:
The package has a cover glass that is bonded to substrate in wafer-level and sealed hermetically.

25. The optical system of claim 12 wherein:
The package has a cover glass that is bonded to substrate in wafer-level and sealed hermetically and the substrate is connected to a heat sink.

26. The optical system of claim 12 wherein:
The mirror of the speckle remover has a high reflectance surface from a group of a layer of silver and multi-layers of dielectric materials whose total reflectance is over 90%.
